(19) United States
(12) Patent Application Publication
(10) Pub. No.: US 2026/0358618 A1
(43) Pub. Date: Nov. 12, 2026

(54) MAGNIFYING OBSERVATION SYSTEM AND STORAGE MEDIUM

(71) Applicant: Evident Corporation, Kamiina-gun (JP)

(72) Inventors: Kenichi KUSAKA, Kamiina-gun (JP); Yukinari KONDO, Kamiina-gun (JP); Hirofumi HORI, Kamiina-gun (JP); Tomoya MATSUZAKI, Kamiina-gun (JP); So HIBINO, Kamiina-gun (JP)

(73) Assignee: Evident Corporation, Kamiina-gun (JP)

(21) Appl. No.: 19/561,354

(22) Filed: Mar. 9, 2026

Related U.S. Application Data
(63) Continuation of application No. PCT/JP2025/017159, filed on May 12, 2025.

(51) Int. Cl. G02B 21/36; G02B 21/24

(52) U.S. Cl. CPC G02B 21/368; G02B 21/248; G02B 21/367

(57) ABSTRACT

A magnifying observation system includes a drive unit that drives a stage on which a sample is placed, a first imaging element that receives light from the sample via a first optical system including a first objective lens that is object-side telecentric and generates a first image of the sample, a second imaging element that receives light from the sample via a second optical system including a second objective lens that is object-side non-telecentric and generates a second image of the sample having a wider field of view than the first image, a memory that stores pixel sizes of the first imaging element and/or the second imaging element, and calibration parameters, and a processor.

### CROSS REFERENCE TO RELATED APPLICATIONS

This application is a continuation application of International Application PCT/JP2025/017159 filed on May 12, 2025, the entire contents of which are incorporated herein by reference.

### BACKGROUND OF THE INVENTION

### Field of the Invention

The disclosure of the present specification relates to a magnifying observation system, a program, and a storage medium.

### Description of the Related Art

In subject inspection using an industrial microscope, wide-field observation (macro observation) for observing an overall image of the subject and fine observation (micro observation) for observing a detailed portion of the subject are used in combination. This is because an overview of the subject is ascertained from a macro image acquired during macro observation, a state at a specific position of the subject is ascertained from a micro image acquired during micro observation, and these are linked to each other. This linking is also referred to as mapping.

As an apparatus that can be used for such subject inspection, an image inspection apparatus described in Japanese Patent No. 7154069 is known. This image inspection apparatus includes a first camera having a telecentric optical system that images a work placed on a stage and generates a work image, and a second camera (overview camera) having a non-telecentric optical system, the second camera having an imaging field of view wider than an imaging field of view of the first camera, imaging the work placed on the stage via an optical system different from an optical system of the first camera, and generating an overview image. Then, control is performed such that the stage is moved so that the work is positioned within or near the imaging field of view of the first camera based on a position of the work on the stage detected from the overview image. In this image inspection apparatus, since individual differences occur in an attachment position and an orientation of the second camera, in order to accurately convert a specific position in a coordinate system of the second camera into a specific position in a coordinate system of the first camera, the coordinate system of the second camera is calibrated based on calibration information. The calibration information is created based on measurement results obtained by measuring an amount of deviation of the attachment position and an amount of deviation of the attachment orientation of the second camera at the time of assembly in a factory.

### SUMMARY

A magnifying observation system according to an aspect of the present invention includes a stage on which a sample is placed, a drive unit that drives the stage, a first optical system including a first objective lens that is object-side telecentric, a first imaging element that receives light from the sample via the first optical system and generates a first image of the sample, a second optical system including a second objective lens that is object-side non-telecentric, in which an optical axis of the second objective lens is parallel to an optical axis of the first objective lens, a second imaging element that receives light from the sample via the second optical system and generates a second image of the sample having a wider field of view than the first image, a memory that stores pixel sizes of the first imaging element and/or the second imaging element, and calibration parameters, a display that displays the first image and/or the second image, and a processor, in which the processor acquires the second image of the sample by the second imaging element, calculates a magnification of the second image based on dimension information based on the second image, and the pixel sizes and the calibration parameters stored in the memory, accepts designation of a position with respect to the sample represented in the second image displayed on the display, controls the drive unit based on the position and the magnification such that the position is positioned at a position of the optical axis of the first objective lens, and acquires, by the first imaging element, the first image of the sample.

A storage medium according to an aspect of the present invention is a computer-readable storage medium storing a program for causing a computer of a magnifying observation system including a stage on which a sample is placed, a drive unit that drives the stage, a first optical system including a first objective lens that is object-side telecentric, a first imaging element that receives light from the sample via the first optical system and generates a first image of the sample, a second optical system including a second objective lens that is object-side non-telecentric, in which an optical axis of the second objective lens is parallel to an optical axis of the first objective lens, a second imaging element that receives light from the sample via the second optical system and generates a second image of the sample having a wider field of view than the first image; a memory that stores pixel sizes of the first imaging element and/or the second imaging element, and calibration parameters, and a display that displays the first image and/or the second image, to execute processing of acquiring, by the second imaging element, the second image of the sample, calculating a magnification of the second image based on dimension information based on the second image, and the pixel sizes and the calibration parameters stored in the memory, accepting designation of a magnifying position with respect to the sample represented in the second image displayed on the display, controlling the drive unit based on the magnifying position and the magnification such that the magnifying position is positioned at a position of an optical axis of the first objective lens, and acquiring, by the first imaging element, the first image of the magnifying position of the sample.

A magnifying observation system according to another aspect of the present invention includes a stage on which a sample is placed, a drive unit that drives the stage, a first optical system including a first objective lens that is object-side telecentric, a first imaging element that receives light from the sample via the first optical system and generates a first image of the sample, a second optical system including a second objective lens that is object-side non-telecentric, in which an optical axis of the second objective lens is parallel to an optical axis of the first objective lens, a second imaging element that receives light from the sample via the second optical system and generates a second image of the sample having a wider field of view than the first image, a memory that stores pixel sizes of the first imaging element and/or the second imaging element, and calibration parameters, a display that displays the first image and/or the second image, and a processor, in which the processor acquires the second image of the sample by the second imaging element, calculates a magnification of the second image based on dimension information based on the second image, and the pixel sizes and the calibration parameters stored in the memory, displays, on the display, the first image of the sample acquired by the first imaging element, and the second image, acquires, from the drive unit, position information of the stage at a time when the first image is acquired, and displays, on the second image displayed on the display, a position at which the first image is acquired based on the magnification of the second image and the position information.

### BRIEF DESCRIPTION OF THE DRAWINGS

FIG. 1 is a diagram illustrating a configuration of a magnifying observation system.

FIG. 2 is a diagram illustrating a macro observation example using a macro camera detached from an optical head.

FIG. 3 is a diagram illustrating a state in which a part of a frame that holds an optical head is inclined.

FIG. 4 is a diagram illustrating a hardware configuration of a computer that realizes a control device.

FIG. 5 is a flowchart illustrating an outline of mapping processing.

FIG. 6 is a diagram illustrating a display example in which a macro image and a plurality of micro images are associated with each other.

FIG. 7 is a diagram illustrating a comparative example between a case where a second objective lens of a macro camera is object-side non-telecentric and a case where the second objective lens is object-side telecentric.

FIG. 8 is a diagram illustrating a magnifying position designated with respect to a sample represented in a macro image.

FIG. 9 is a diagram illustrating a display example in which a macro image and a micro image are associated with each other.

FIG. 10 is a diagram illustrating Method 1.

FIG. 11 is a flowchart illustrating details of mapping processing including processing of obtaining a magnification of a macro image by Method 1.

FIG. 12 is a diagram illustrating Method 2.

FIG. 13 is a flowchart illustrating details of mapping processing including processing of obtaining a magnification of a macro image by Method 2.

FIG. 14 is a diagram illustrating a registration screen.

FIG. 15 is a diagram illustrating a macro image acquisition screen.

FIG. 16 is a flowchart illustrating details of mapping processing including processing of obtaining a magnification of a macro image by Method 3.

FIG. 17 is a diagram illustrating a macro image acquisition screen.

FIG. 18 is a diagram schematically illustrating an amount of displacement in an X direction of a sample represented in a macro image.

FIG. 19 is a flowchart illustrating details of mapping processing including processing of obtaining a magnification of a macro image by Method 4.

FIG. 20 is a diagram illustrating a relationship between a distance between a second objective lens and a sample and a magnification of the second objective lens.

FIG. 21 is a diagram illustrating Method 5.

FIG. 22 is a flowchart illustrating details of mapping processing including processing of obtaining a magnification of a macro image by Method 5.

FIG. 23 is a diagram schematically illustrating examples in which L differs in a microscope to which a macro camera is attached.

FIG. 24 is a diagram schematically illustrating a microscope to which macro cameras having different WD are attached.

FIG. 25 is a diagram illustrating an example of a navigation display.

FIG. 26 is a flowchart illustrating processing related to a navigation function.

### DESCRIPTION OF THE EMBODIMENTS

In a case where a camera having an object-side non-telecentric optical system is used, such as the second camera of Japanese Patent No. 7154069, since a magnification changes depending on a distance between the object-side non-telecentric optical system and a subject, the magnification becomes unknown depending on a height of the subject. Therefore, in the image inspection apparatus of Japanese Patent No. 7154069, it is not possible to flexibly calibrate a coordinate system of the second camera only with calibration information based on an attachment position and an orientation of the second camera. In the present specification, the magnification means an optical magnification, and more specifically means a ratio of a size of an optical image to a size of an object.

Hereinafter, embodiments of the present invention will be described with reference to the drawings.

### First Embodiment

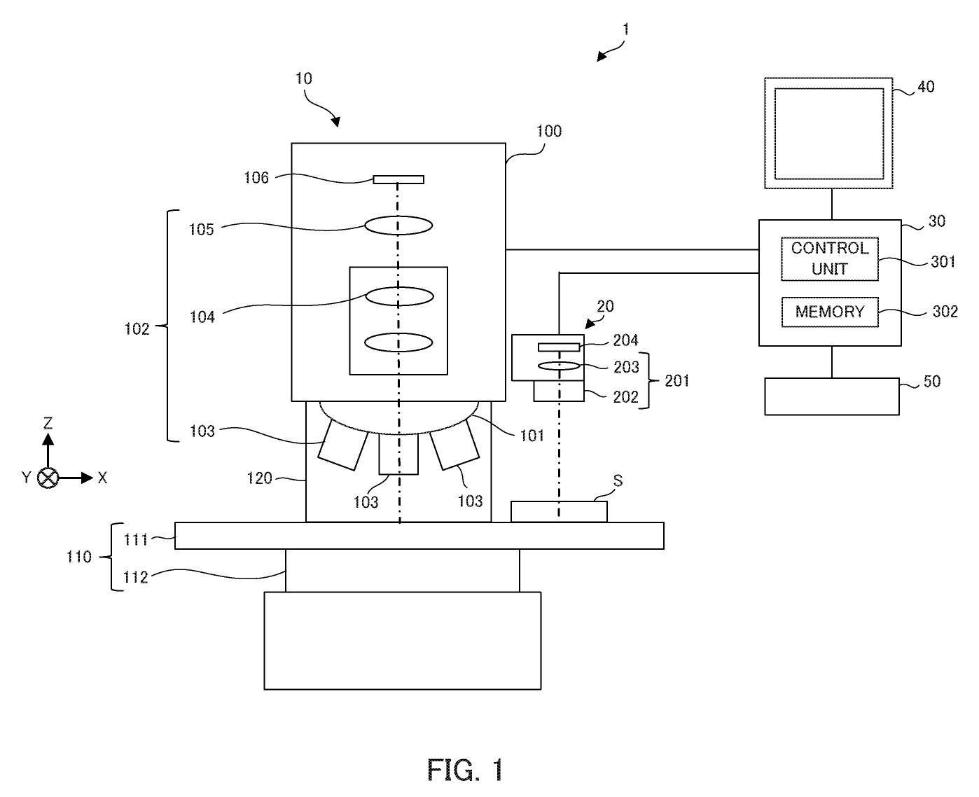

FIG. 1 is a diagram illustrating a configuration of a magnifying observation system.

A magnifying observation system 1 illustrated in FIG. 1 is a system used for subject inspection and the like, and includes a microscope 10, a macro camera 20, a control device 30, a display 40, and an input device 50. The magnifying observation system 1 is also a digital microscope including the macro camera 20.

The microscope 10 includes an optical head 100, an electric XY stage 110, and a frame 120.

The optical head 100 includes a revolver 101, a first optical system 102, and a first imaging element 106. The first optical system 102 is an optical system for micro observation, and includes a first objective lens 103, a zoom optical system 104, and an imaging lens 105. The first optical system 102 may be configured not to include the zoom optical system 104.

The revolver 101 holds a plurality of first objective lenses 103 having different magnifications, and inserts, by rotation, the first objective lens 103 to be used for micro observation into an optical path. The rotation of the revolver 101 is performed electrically under control of the control device 30, but may be performed manually. Instead of the revolver 101, a slide mechanism that holds a plurality of first objective lenses 103 having different magnifications and inserts, by sliding, a first objective lens 103 to be used for micro observation into the optical path may be provided.

The first objective lens 103 is an object-side telecentric objective lens. Therefore, even when a distance between the first objective lens 103 inserted into an optical path and a sample S that is a subject changes, a magnification does not change.

The zoom optical system 104 changes a magnification. The zoom optical system 104 is configured to change the magnification by moving a movable lens of a zoom lens group, but may be configured to change the magnification by switching fixed-magnification lenses. The magnification change by the zoom optical system 104 is performed electrically under control of the control device 30, but may be performed manually.

The imaging lens 105 collects light from a sample S via the first objective lens 103 and the zoom optical system 104 and forms an observation image (micro observation image).

The first imaging element 106 receives the observation image formed by the imaging lens 105 and generates a micro image that is a first image of the sample S by performing photoelectric conversion. That is, the first imaging element 106 receives light from the sample S via the first optical system 102 and generates a micro image of the sample S. The generated micro image is output to the control device 30. The first imaging element 106 is, for example, an image sensor such as a Charge Coupled Device (CCD) or a Complementary Metal Oxide Semiconductor (CMOS).

The optical head 100 further includes a light source and a coaxial episcopic illumination optical system (not illustrated) such that illumination of the sample S is performed via the first objective lens 103.

The electric XY stage 110 includes a stage 111 on which the sample S is placed, and a drive unit 112 that drives the stage 111 in X and Y directions. The drive unit 112 includes an actuator such as a stepping motor, and is a drive mechanism that drives the stage 111 in the X and Y directions by the actuator. The X and Y directions are also directions perpendicular to an optical axis of the first objective lens 103 inserted into the optical path. Driving of the stage 111 is performed electrically by the drive unit 112 under control of the control device 30, but may be performed manually.

The frame 120 is provided with the electric XY stage 110 and holds the optical head 100 to be drivable in a Z direction. The Z direction is also a direction parallel to an optical axis of the first objective lens 103 inserted into the optical path. Driving of the optical head 100 is performed electrically under control of the control device 30, but may be performed manually. Driving of the optical head 100 is performed, for example, to focus on the sample S. Focusing on the sample S is performed automatically, but may be performed manually. Instead of driving the optical head 100 in the Z direction, the electric XY stage 110 may be configured to be driven in the Z direction.

The macro camera 20 is detachably attached to the optical head 100. The macro camera 20 includes a second optical system 201 and a second imaging element 204. The second optical system 201 is an optical system for macro observation, and includes a second objective lens 202 and an imaging lens 203.

The second objective lens 202 is an object-side non-telecentric objective lens. Therefore, when a distance between the second objective lens 202 and the sample S changes, a magnification also changes. When the macro camera 20 is attached to the optical head 100, an optical axis of the second objective lens 202 is parallel to an optical axis of the first objective lens 103 inserted into the optical path.

The imaging lens 203 collects light from the sample S via the second objective lens 202 and forms an observation image (macro observation image).

The second imaging element 204 receives the observation image formed by the imaging lens 203 and generates a macro image that is a second image of the sample S by performing photoelectric conversion. That is, the second imaging element 204 receives light from the sample S via the second optical system 201 and generates a macro image of the sample S. The macro image is an image having a wider field of view than the micro image. The second imaging element 204 outputs the generated macro image to the control device 30. The second imaging element 204 is, for example, an image sensor such as a CCD or a CMOS.

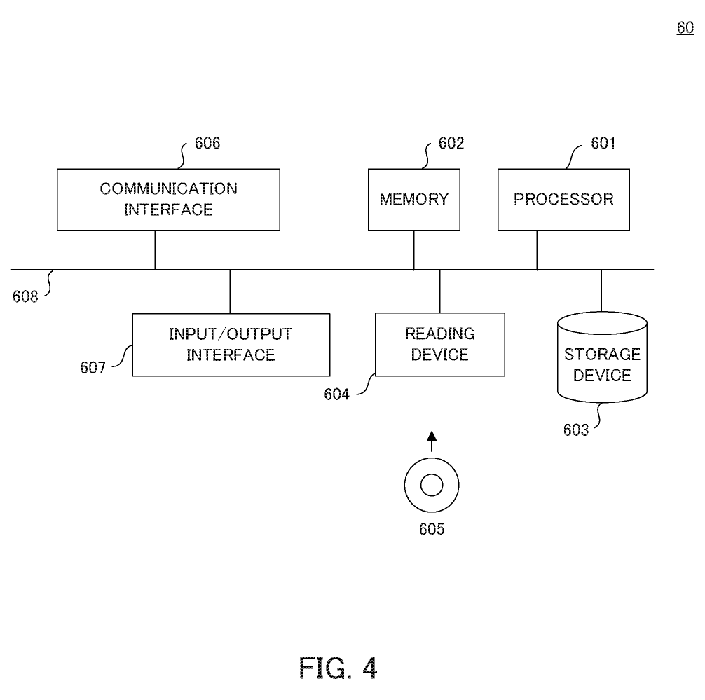

The control device 30 includes a control unit 301 and a memory 302. The control unit 301 controls operation of the magnifying observation system 1. For example, the control unit 301 controls rotation of the revolver 101, change of magnification of the zoom optical system 104, driving of the stage 111, driving of the optical head 100, driving of the optical head 100 for automatic focusing on the sample S by the first optical system, display of macro images and/or micro images on the display 40, and the like. Further, the control unit 301 can acquire, from the microscope 10, a position of the revolver 101, a lens position of the zoom optical system 104, a position (XY coordinates) of the stage 111, a position (Z coordinate) of the optical head 100, and the like. Accordingly, the control unit 301 can acquire, for example, a magnification of the first objective lens 103 inserted into the optical path, a magnification of the zoom optical system 104, a magnification of the first optical system 102, and the like. The control unit 301 acquires, for example, XY coordinates or a driving amount (movement amount) from the drive unit 112 as position information of the stage 111. Further, the control unit 301 performs mapping processing described later. The memory 302 stores pixel sizes of the first imaging element 106 and/or the second imaging element 204, calibration parameters described later, and the like. The control device 30 having such a configuration is realized by, for example, a computer illustrated in FIG. 4 described later.

The display 40 displays various screens. For example, the display 40 displays a screen including a micro image and/or a macro image under control of the control device 30. The display 40 is, for example, a liquid crystal display or an organic Electro-Luminescence (EL) display.

The input device 50 accepts various inputs from a user and outputs the inputs to the control device 30. For example, the input device 50 accepts, from the user, inputs such as an instruction to switch the first objective lens 103, an instruction to change magnification of the zoom optical system 104, an instruction to drive the stage 111, and an instruction to focus on the sample S. Further, the input device 50 accepts, from the user, an input to designate a magnifying position with respect to the sample S represented in the macro image displayed on the display 40. The input device 50 includes, for example, one or more of a mouse, a keyboard, a joystick, and a touch panel. The touch panel may be disposed on a display surface of the display 40.

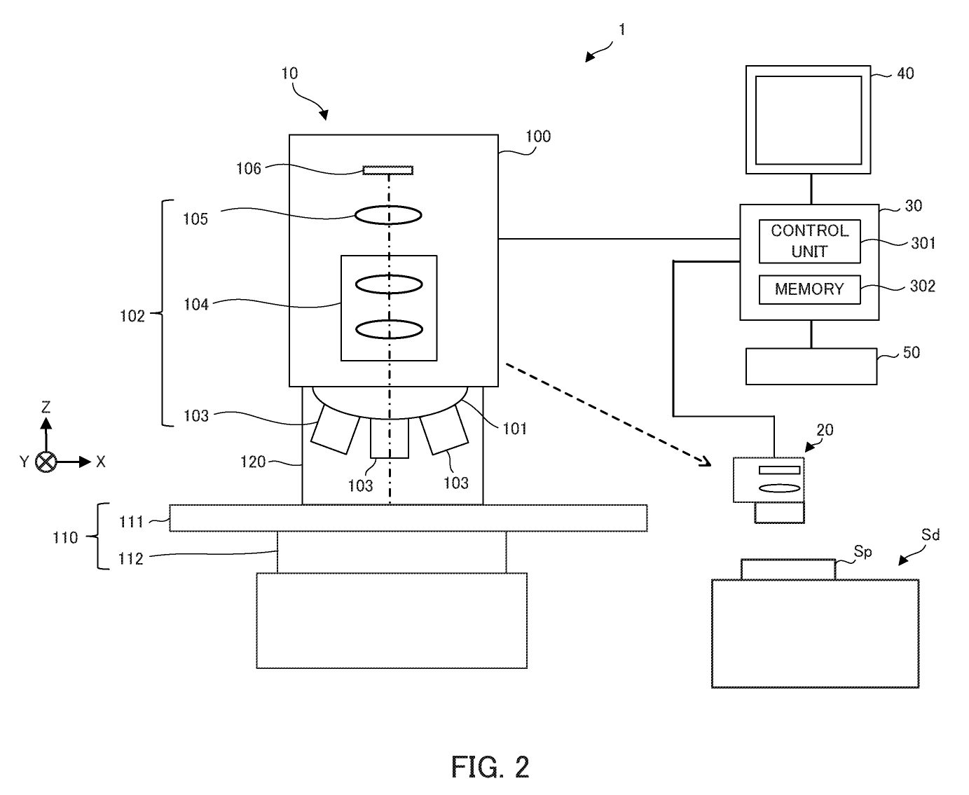

In the magnifying observation system 1 having such a configuration, as described above, the macro camera 20 is detachably attached to the optical head 100 of the microscope 10. Therefore, the user can also perform macro observation by removing the macro camera 20 from the optical head 100 and holding the macro camera 20 by hand, as illustrated in FIG. 2.

FIG. 2 is a diagram illustrating a macro observation example using a macro camera detached from an optical head.

In the macro observation example illustrated in FIG. 2, when analyzing a defect of a target apparatus Sd, after performing macro observation of the entire target apparatus Sd using a handheld macro camera 20, it becomes possible to place an attention component Sp of the target apparatus Sd on the stage 111 and observe the component in detail (micro observation) by the microscope 10.

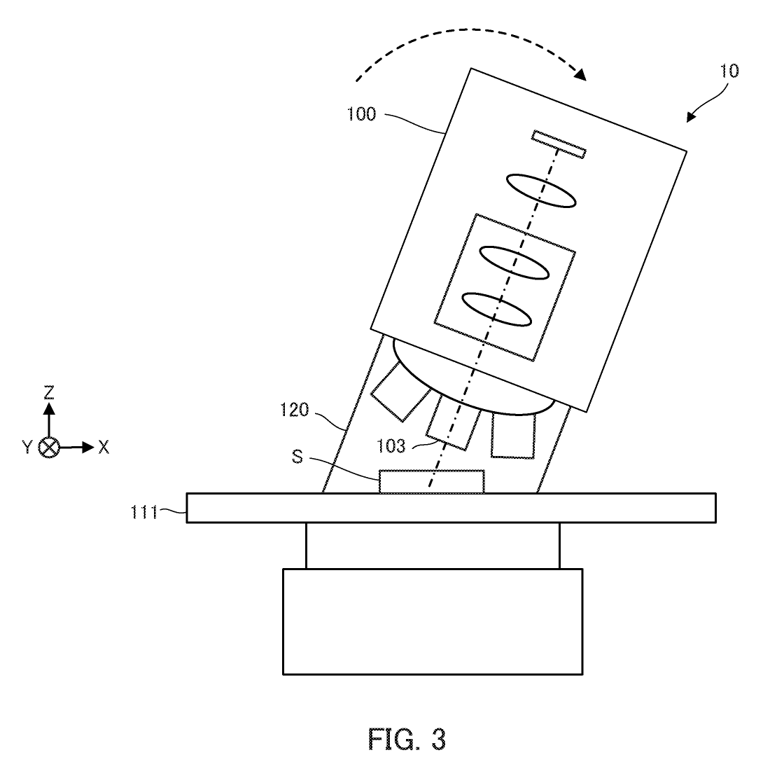

Further, the microscope 10 may be configured such that the sample S can be micro-observed obliquely by inclining a part of the frame 120 that holds the optical head 100, as illustrated in FIG. 3.

FIG. 3 is a diagram illustrating a state in which a part of a frame that holds an optical head is inclined.

The state illustrated in FIG. 3 shows a state in which a part of the frame 120 that holds the optical head 100 is inclined by a specific angle in a clockwise direction. Accordingly, the user can micro-observe the sample S obliquely.

In a configuration in which such inclination is performed, a part of the frame 120 that holds the optical head 100 is configured to incline, for example, about an axis serving as a rotation axis, the axis being parallel to a Y direction and passing through an intersection between an optical axis of the first objective lens 103 inserted into the optical path and a sample placement surface of the stage 111. Such inclination may be performed electrically under control of the control device 30, or may be performed manually.

FIG. 4 is a diagram illustrating a hardware configuration of a computer that realizes a control device.

A computer 60 illustrated in FIG. 4 includes a processor 601, a memory 602, a storage device 603, a reading device 604, a communication interface 606, and an input/output interface 607, each of which is connected to each other via a bus 608.

For example, the processor 601 may be a single processor, a multiprocessor, or a multicore processor. The processor 601 performs various types of processing by reading and executing a program stored in the storage device 603.

The memory 602 is, for example, a semiconductor memory, and includes a Random Access Memory (RAM) region and a Read Only Memory (ROM) region. The storage device 603 is, for example, a hard disk, a semiconductor memory such as a flash memory, or an external storage device.

The reading device 604 accesses a removable recording medium 605, for example, according to an instruction of the processor 601. For example, the removable recording medium 605 is achieved by a semiconductor device, a medium to/from which information is input/output by a magnetic action, a medium to/from which information is input/output by an optical action. The semiconductor device is, for example, a Universal Serial Bus (USB) memory. The medium to which information is input and output by the magnetic effect is, for example, a magnetic disk. The medium to and from which information is input and output by an optical action is, for example, a compact disc (CD)-ROM, a digital versatile disk (DVD), or a Blu-ray (registered trademark) disc, or the like.

The communication interface 606 is connected to a communication network (not illustrated), and, for example, communicates with another apparatus via the communication network in accordance with an instruction from the processor 601.

The input/output interface 607 is connected to an external apparatus, and, for example, transmits and receives data to and from the external apparatus in accordance with an instruction from the processor 601. The external apparatus is, for example, the microscope 10, the macro camera 20, the display 40, and the input device 50.

For example, the program executed by the processor 601 is provided to the computer 60 in the following forms:
(1) Pre-installed on the storage device 603;
(2) provided by the removable recording medium 605; and
(3) provided from a server such as a program server.

In such a computer 60, the processor 601 provides functions of the control unit 301 of the control device 30. One or more of the memory 602, the storage device 603, and the removable recording medium 605 provide functions of the memory 302 of the control device 30.

The hardware configuration of the computer 60 for implementing the control device 30, the computer 60 being described with reference to FIG. 4, is an example, and the embodiments are not limited to this. For example, a part of the configuration may be omitted or a new configuration may be added to the configuration described above. Some or all functions of the control device 30 may be implemented as hardware. A field programmable gate array (FPGA), a system-on-a-chip (SoC), an application specific integrated circuit (ASIC), and a programmable logic device (PLD) are examples of hardware by which the control device 30 can be implemented.

Next, in the magnifying observation system 1, mapping processing will be described as an example of processing performed by the control unit 301 of the control device 30. The mapping processing is processing related to a mapping function included in the magnifying observation system 1, and is processing for linking a micro image of the sample S acquired during micro observation to a macro image of the sample S acquired during macro observation.

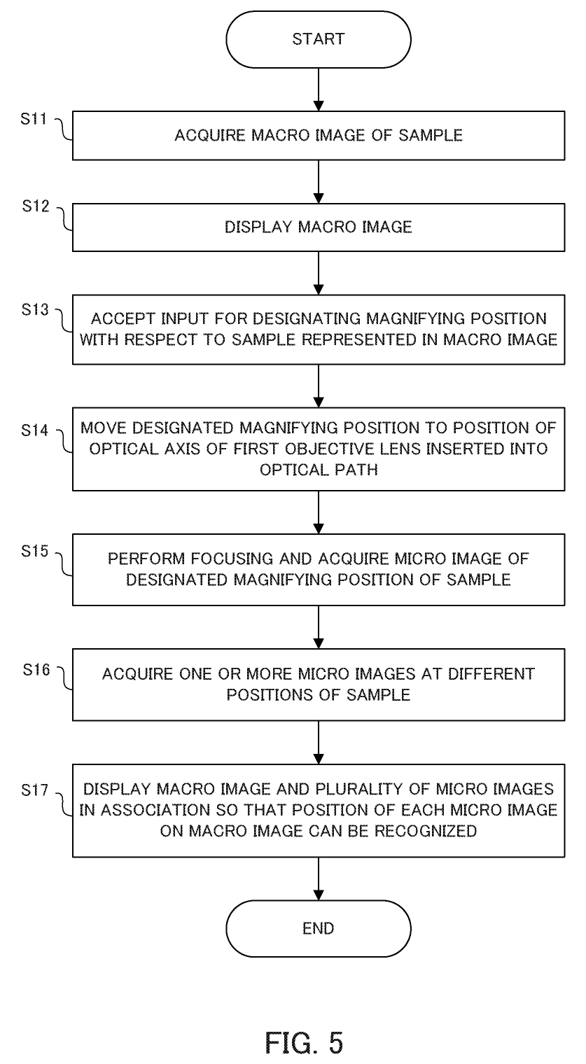

FIG. 5 is a flowchart illustrating an outline of mapping processing.

In the mapping processing illustrated in FIG. 5, first, the control unit 301 acquires a macro image of the sample S placed on the stage 111 by the second imaging element 204 (S11). Here, it is assumed that, in advance, driving of the stage 111 and the optical head 100 has been performed in accordance with a user instruction input, and the sample S is included in an imaging range of the second imaging element 204 (an observation range of the second optical system 201).

Next, the control unit 301 displays the macro image acquired in S11 on the display 40 (S12).

Next, the control unit 301 accepts, from the user, an input for designating a magnifying position with respect to the sample S represented in the macro image displayed in S12 (S13). This input is performed, for example, by a mouse click operation.

When the control unit 301 accepts the input for designating the magnifying position from the user in S13, the control unit 301 moves the designated magnifying position to a position of an optical axis of the first objective lens 103 inserted into the optical path by driving the stage 111 (S14).

Next, the control unit 301 performs focusing (bringing into focus) by the first optical system 102 by driving the optical head 100, and acquires a micro image of the designated magnifying position of the sample S by the first imaging element 106 (S15).

Next, the control unit 301 performs, in accordance with an instruction input of the user, driving of the stage 111, the optical head 100, and the like, and acquisition of a micro image by the first imaging element 106 one or more times, and acquires one or more micro images at different positions of the sample S (S16).

Next, the control unit 301 associates the macro image acquired in S11 with the plurality of micro images acquired in S15 and S16 and displays them on the display 40 such that positions on the macro image of each of the micro images acquired in S15 and S16 can be recognized (S17). In addition, the display content is also included in a report such as an inspection result.

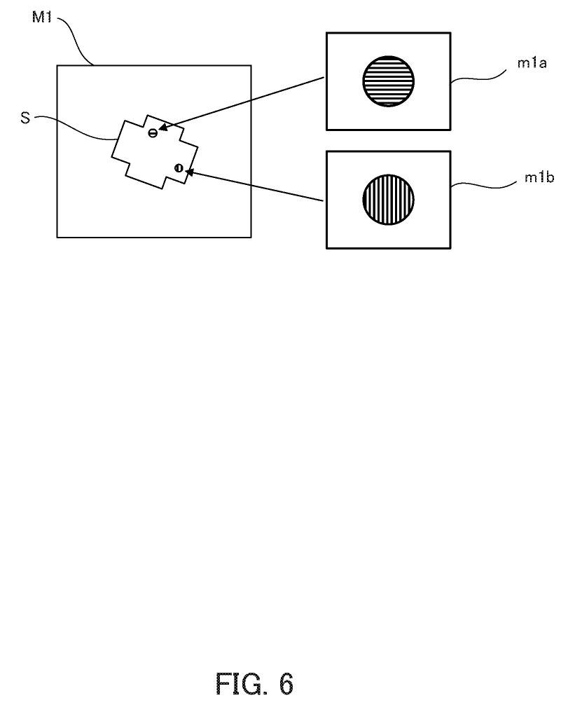

FIG. 6 is a diagram illustrating a display example in which a macro image and a plurality of micro images are associated with each other.

In the display example illustrated in FIG. 6, a macro image M1 and two micro images m1a and m1b are displayed in association with each other such that it can be recognized which position of the sample S represented in the macro image M1 each of the two micro images m1a and m1b corresponds to.

In the magnifying observation system 1, the second objective lens 202 of the macro camera 20 is, as described above, object-side non-telecentric. Here, a reason for setting the second objective lens 202 to be object-side non-telecentric will be described in comparison with a case where it is object-side telecentric.

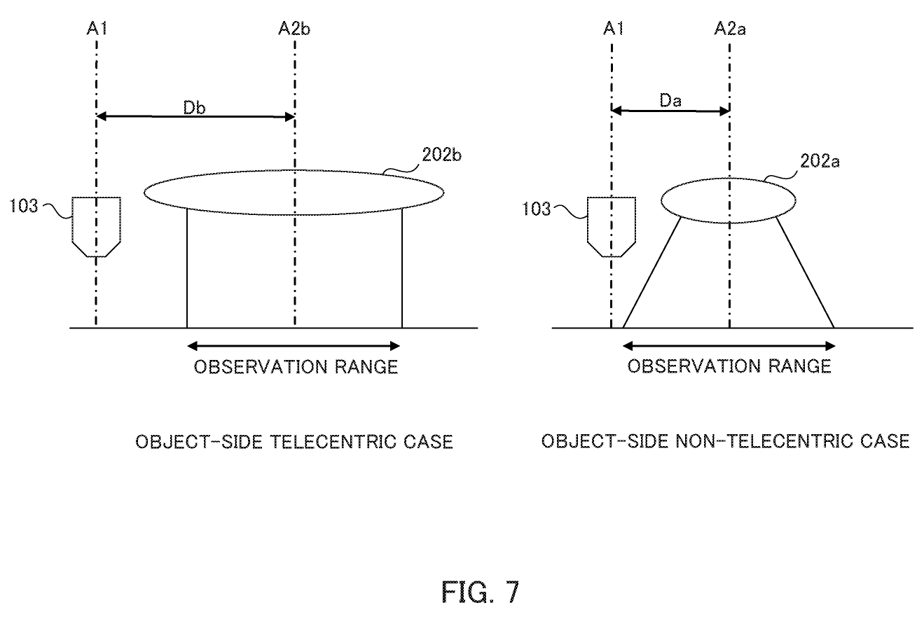

FIG. 7 is a diagram illustrating a comparative example between a case where a second objective lens of a macro camera is object-side non-telecentric and a case where the second objective lens is object-side telecentric. The left side shows the object-side telecentric case, and the right side shows the object-side non-telecentric case.

As illustrated in FIG. 7, an object-side non-telecentric objective lens 202a can have a smaller lens diameter than an object-side telecentric objective lens 202b. This is because, for the object-side telecentric objective lens 202b, a lens diameter larger than an observation range is required. For example, in a case where the observation range is 100 mm, the object-side telecentric objective lens 202b requires a lens diameter of 100 mm or more. In contrast, since the object-side non-telecentric objective lens 202a can have a smaller lens diameter, the macro camera 20 can be reduced in size. Further, when the macro camera 20 is attached to the optical head 100, a distance Da between an optical axis A1 of the first objective lens 103 inserted into the optical path and an optical axis A2a of the object-side non-telecentric objective lens 202a can be made shorter than a distance Db between the optical axis A1 of the first objective lens 103 and an optical axis A2b of the object-side telecentric objective lens 202b. As described above, since a distance between the optical axis of the first objective lens 103 and the optical axis of the second objective lens 202 becomes shorter, for example, a driving distance (movement distance) of the stage 111 in S14 of FIG. 5 described above becomes shorter, and a driving time (movement time) of the stage 111 can be shortened.

On the other hand, in a case where the second objective lens 202 is object-side non-telecentric, there is a problem that a magnification of a macro image changes depending on a distance between the second objective lens 202 and the sample S. In particular, when a field of view of the second objective lens 202 is wide, an object-side Numerical Aperture (NA) becomes small and a depth of focus becomes deep, and thus a range in which focus is achieved becomes wide, and the user cannot recognize where focus is achieved. In a case of observing the sample S having irregularities of various heights, this becomes a problem.

Because such a problem exists, for example, in S14 of FIG. 5 described above, when the stage 111 is driven to move the designated magnifying position to a position of the optical axis of the first objective lens 103 inserted into the optical path, a movement distance of the stage 111 is not accurately determined.

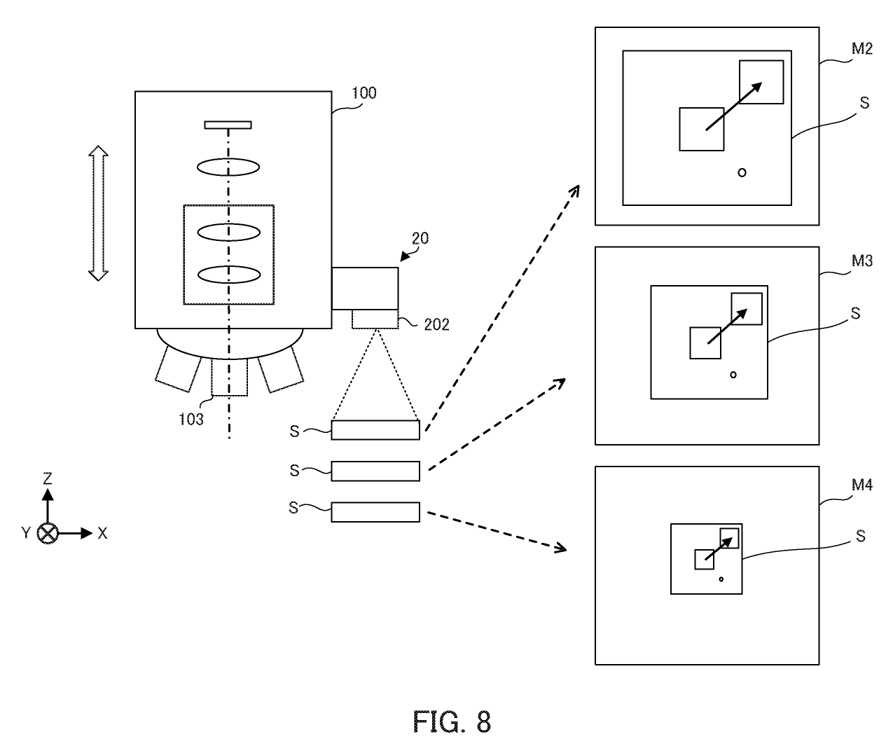

FIG. 8 is a diagram illustrating a magnifying position designated with respect to a sample represented in a macro image.

FIG. 8 illustrates three macro images M2, M3, and M4 in which distances between the second objective lens 202 and the sample S are different. In each of the macro images, a magnifying position designated with respect to the sample S represented in the macro image is shown as an end point of a solid arrow. A start point of the solid arrow indicates a center position of the macro image. The center position of the macro image corresponds to a position of the optical axis of the second objective lens 202.

As illustrated in FIG. 8, since a magnification of a macro image changes depending on a distance between the second objective lens 202 and the sample S, the magnification of the macro image becomes unknown. Therefore, when the stage 111 is driven so as to move the designated magnifying position to the position of the optical axis of the first objective lens 103 inserted into the optical path, a distance corresponding to a length of the solid arrow on the macro image is not determined, and thus a movement distance of the stage 111 is not determined.

As described above, when the magnification of the macro image is unknown, for example, in S17 of FIG. 5 described above, it is not possible to display the macro image and the micro image in association with each other such that it can be recognized which position of the macro image the micro image corresponds to.

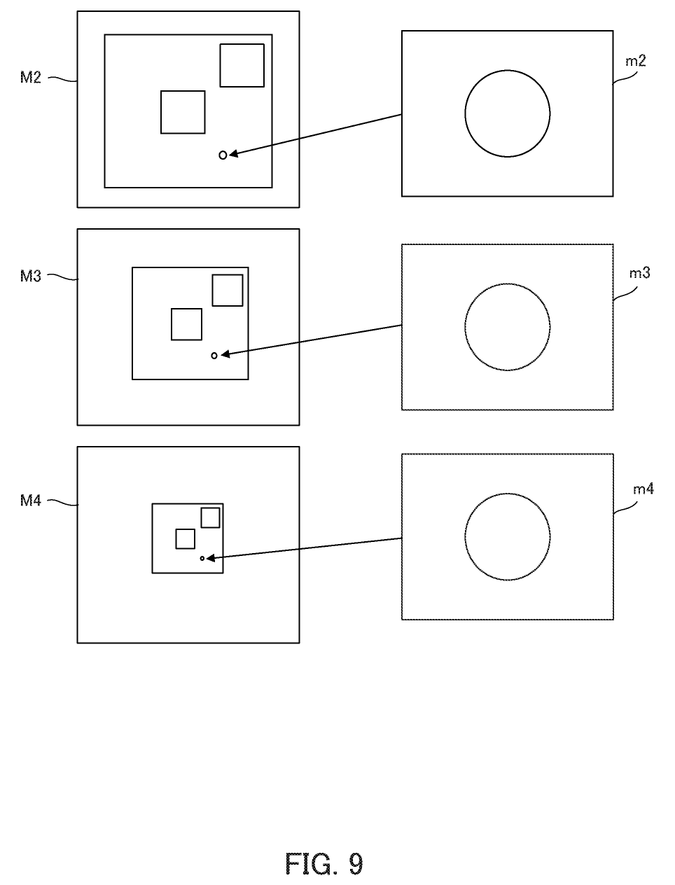

FIG. 9 is a diagram illustrating a display example in which a macro image and a micro image are associated with each other.

FIG. 9 illustrates a display example in which a macro image M2 and a micro image m2 are associated with each other, a display example in which a macro image M3 and a micro image m3 are associated with each other, and a display example in which a macro image M4 and a micro image m4 are associated with each other.

Originally, as in the display example of FIG. 9, the macro image and the micro image should be displayed in association with each other such that it can be recognized which position of the macro image the micro image corresponds to; however, when the magnification of the macro image is unknown, such display cannot be performed.

In view of the above-described problems, in the magnifying observation system 1, the mapping processing whose outline has been described with reference to FIG. 5 is performed in detail as follows.

In the first embodiment, mapping processing including processing for obtaining a magnification of a macro image by Method 1 is performed. Method 1 is a method of obtaining the magnification of the macro image by using the stage 111 provided with a scale on a sample placement surface and comparing a scale represented in the macro image with the sample S in size.

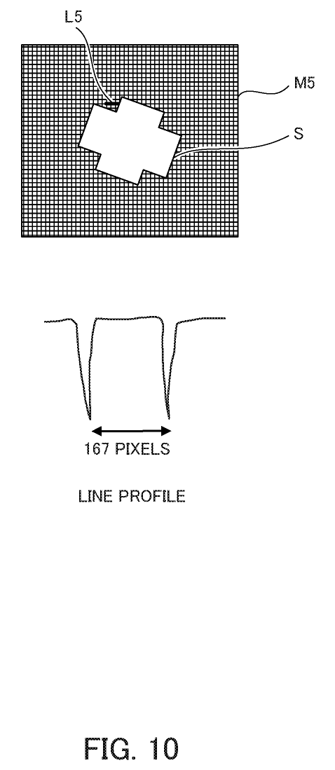

FIG. 10 is a diagram illustrating Method 1.

In FIG. 10, a macro image M5 is a macro image of the sample S placed on the stage 111 on which a grid-shaped scale is provided on the sample placement surface. A relative dimension of a spacing of the scale represented in the macro image M5 is obtained by acquiring, for example, a line profile of a horizontal line L5 near a center of the macro image M5. A reason for acquiring the line profile near the center of the macro image M5 is that an influence of distortion of the second objective lens 202 is small. The relative dimension of the spacing of the scale represented in the macro image M5 is also dimension information based on the macro image M5. The scale provided on the stage 111 is not limited to a grid, and may be other than a grid. For example, the scale may be graduations like a ruler, or a grid-pattern sheet may be placed on the stage 111.

For example, it is assumed that the relative dimension of the spacing of the scale represented in the macro image M5 is 167 pixels based on the line profile. An absolute dimension of the spacing of the scale provided on the stage 111 and a pixel size of the second imaging element 204 are known. For example, in a case where the absolute dimension of the spacing of the scale provided on the stage 111 is 10 mm and the pixel size of the second imaging element 204 is 2.4 μm, a magnification of the macro image (image size/object size) in this case is as follows.
167×0.0024/10=0.04008

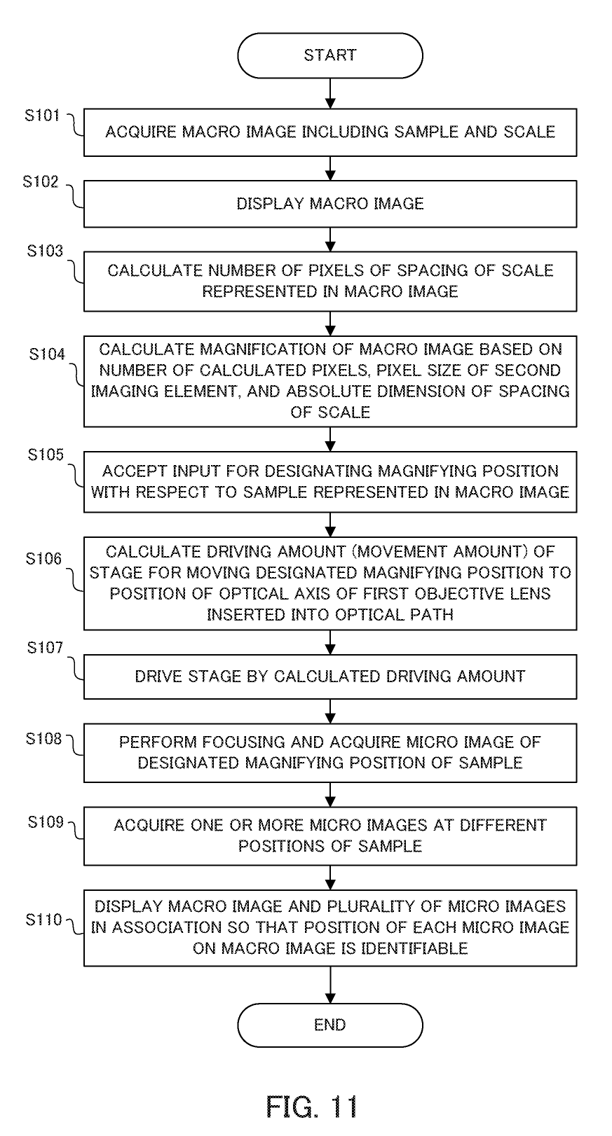

FIG. 11 is a flowchart illustrating details of mapping processing including processing of obtaining a magnification of a macro image by Method 1. In this processing, it is assumed in advance that the absolute dimension of the spacing of the scale provided on the stage 111 is stored in the memory 302 as a calibration parameter.

In the mapping processing illustrated in FIG. 11, first, the control unit 301 acquires, by the second imaging element 204, a macro image including the sample S placed on the stage 111 and the scale provided on the stage 111 (S101). Here, it is assumed that, in advance, driving of the stage 111 and the optical head 100 has been performed in accordance with a user instruction input, and the sample S and the scale provided on the stage 111 are included in an imaging range of the second imaging element 204 (an observation range of the second optical system 201).

Next, the control unit 301 displays the macro image acquired in S101 on the display 40 (S102).

Next, the control unit 301 calculates a number of pixels (relative dimension) of the spacing of the scale represented in the macro image acquired in S101 (S103). This calculation is performed, as illustrated in FIG. 10, based on, for example, a line profile in a horizontal direction of the scale represented near the center of the macro image. The number of pixels calculated in S103 is also dimension information based on the macro image.

Next, the control unit 301 calculates the magnification of the macro image based on the number of pixels calculated in S103, the pixel size of the second imaging element 204 stored in the memory 302, and the absolute dimension of the spacing of the scale, as described with reference to FIG. 10 (S104).

Next, the control unit 301 accepts, from the user, an input for designating a magnifying position with respect to the sample S represented in the macro image displayed on the display 40 in S102 (S105). This input is performed, for example, by a mouse click operation.

When the input for designating the magnifying position is accepted in S105, the control unit 301 calculates a driving amount (movement amount) of the stage 111 for moving the designated magnifying position to a position of an optical axis of the first objective lens 103 inserted into the optical path (S106). This calculation is performed based on, for example, a center position of the macro image acquired in S101, a position on the macro image where the magnifying position is designated in S105, the pixel size of the second imaging element 204, the magnification of the macro image calculated in S104, and a distance between optical axes of the first optical system 102 and the second optical system 201.

Next, the control unit 301 drives the stage 111 by the driving amount calculated in S106 (S107). As a result, the designated magnifying position moves to a position of the optical axis of the first objective lens 103 inserted into the optical path. Next, the control unit 301 performs focusing (bringing into focus) by the first optical system 102 by driving the optical head 100, and acquires a micro image of the designated magnifying position of the sample S by the first imaging element 106 (S108).

Next, the control unit 301 performs, in accordance with an instruction input of the user, driving of the stage 111, the optical head 100, and the like, and acquisition of a micro image by the first imaging element 106 one or more times, and acquires one or more micro images at different positions of the sample S (S109).

Next, the control unit 301 associates the macro image acquired in S101 with the plurality of micro images acquired in S108 and S109 and displays them on the display 40 such that positions on the macro image of each of the micro images acquired in S108 and S109 can be recognized (S110). For example, the display content is also included in a report such as an inspection result. The display in S110 is performed, for example, based on XY coordinates of the macro image acquired in S101 (XY coordinates of a position of the stage 111 when the macro image was acquired), the magnification of the macro image calculated in S104, XY coordinates of each of the micro images acquired in S108 and S109 (XY coordinates of a position of the stage 111 when each micro image was acquired), a magnification of each micro image (a magnification of the first optical system 102 when each micro image was acquired), and the like.

In the above-described processing, the magnification is obtained using the scale near the center of the macro image in order to reduce an influence of distortion of the macro image; however, if image distortion correction is performed based on grid information of the macro image, the scale near the center of the macro image does not need to be used. Further, a macro image without distortion can be obtained.

Further, in the above-described processing, association between the macro image and the micro image after acquisition of the micro image has been described; however, when the magnification of the macro image is obtained, it is also possible to display, on the display 40, navigation display indicating which position on the macro image is being observed when observing the micro image.

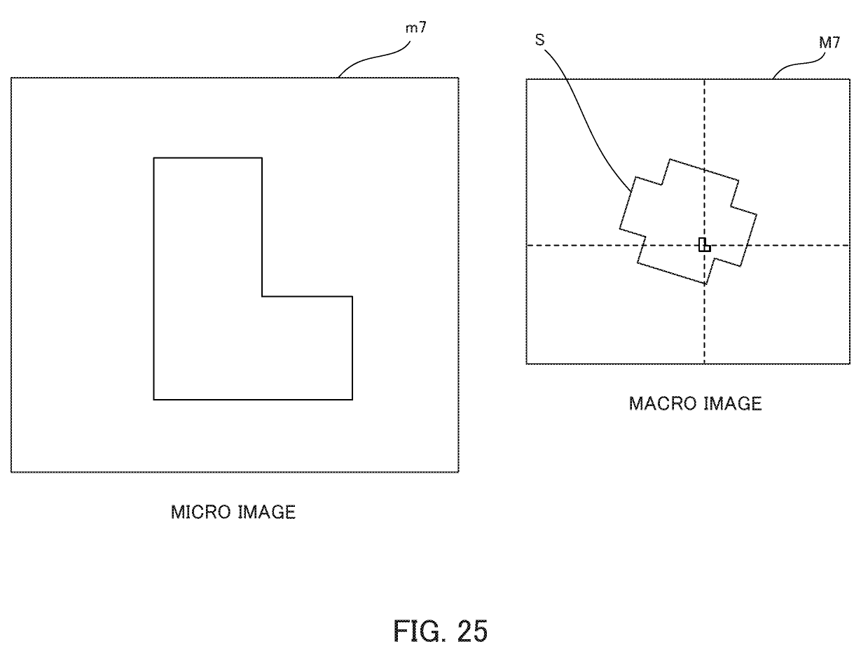

FIG. 25 is a diagram illustrating an example of a navigation display. On a right side of the display 40, an acquired macro image M7 is displayed, and on a left side, a micro image m7 is displayed. In FIG. 25, illustration of a scale is omitted. The acquired micro image m7 is sequentially displayed as a live image. An intersection point of a vertical dotted line and a horizontal dotted line of the macro image M7 indicates a location currently being observed in the micro image m7. With such a navigation function, an observation position of the micro image m7 with respect to an overall image of an observation sample S can be grasped, which is effective for defect analysis and the like of the observation sample S.

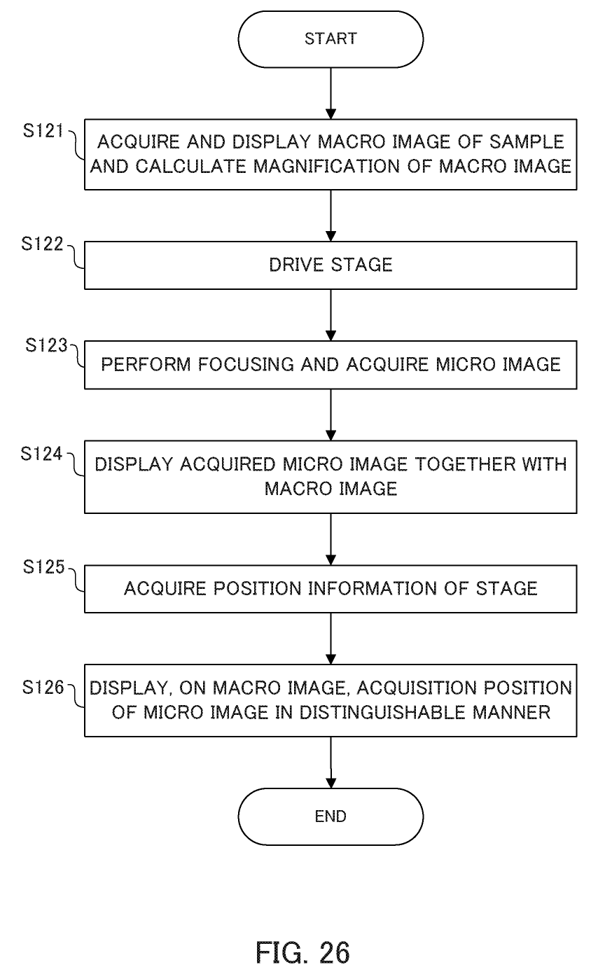

FIG. 26 is a flowchart illustrating processing related to a navigation function.

In the processing illustrated in FIG. 26, first, the control unit 301 acquires and displays a macro image of the sample S and calculates a magnification of the macro image, in the same manner as the processing of S101 to S104 of FIG. 11 (S121).

Next, the control unit 301 drives the stage 111 by a distance between optical axes of the first optical system 102 and the second optical system 201 such that an observation position on the sample S by the second optical system 201 moves to a position of the optical axis of the first optical system 102 (S122). In the processing related to the navigation function, the user does not need to designate a position on the macro image.

Next, the control unit 301 performs focusing (bringing into focus) by the first optical system 102 by driving the optical head 100, acquires a micro image by the first imaging element 106 (S123), and displays the acquired micro image on the display 40 together with the macro image displayed in S121 (S124). As a result, for example, as in the navigation display illustrated in FIG. 25, the macro image and the micro image are displayed on the display 40.

Next, the control unit 301 acquires position information (XY coordinates or a driving amount (movement amount), and the like) of the stage 111 when the micro image is acquired in S123 (S125).

Next, the control unit 301 displays, on the macro image displayed on the display 40, an acquisition position of the micro image displayed on the display 40 in a distinguishable manner based on the magnification acquired in S121 and the position information acquired in S125 (S126). As a result, for example, as in the navigation display illustrated in FIG. 25, the acquisition position of the micro image is displayed on the macro image in a distinguishable manner. The acquisition position of the micro image displayed on the macro image in a distinguishable manner may be displayed in a distinguishable manner by a method other than indicating by an intersection point of a vertical dotted line and a horizontal dotted line in a distinguishable manner.

In the processing illustrated in FIG. 26, after the processing of S122, the processing of S123 to S126 is sequentially repeated. As a result, micro images are sequentially acquired and displayed as live images, position information of the stage 111 is sequentially acquired, and the acquisition position of the micro image displayed on the macro image in a distinguishable manner is sequentially updated. For example, in a case where driving of the stage 111 is performed in accordance with a user instruction input, during and after the driving, micro images are sequentially acquired and displayed as live images, position information of the stage 111 is sequentially acquired, and the acquisition position of the micro image displayed on the macro image in a distinguishable manner is sequentially updated.

With such a navigation function, particularly in a case where an observation position is moved while a micro image is displayed live, a location that the user is currently observing can be displayed on a macro image, thereby making it possible to improve inspection efficiency by a mapping function using both macro observation and micro observation. Such a navigation function is also applicable to embodiments described below.

As described above, according to the first embodiment, since a magnification of a macro image can be obtained by Method 1, the macro image and the micro image can be linked to each other such that a position of the micro image on the macro image can be recognized, and the mapping processing can be smoothly performed. Therefore, inspection efficiency by a mapping function in which macro observation and micro observation are used in combination can be improved.

### Second Embodiment

In the second embodiment, instead of the mapping processing including the processing for obtaining the magnification of the macro image by Method 1 described in the first embodiment, mapping processing including processing for obtaining the magnification of the macro image by Method 2 is performed. Method 2 is a method of acquiring a macro image and a micro image, identifying a specific portion common to both by pattern matching, and obtaining the magnification of the macro image based on sizes of the specific portion represented in the macro image and the micro image.

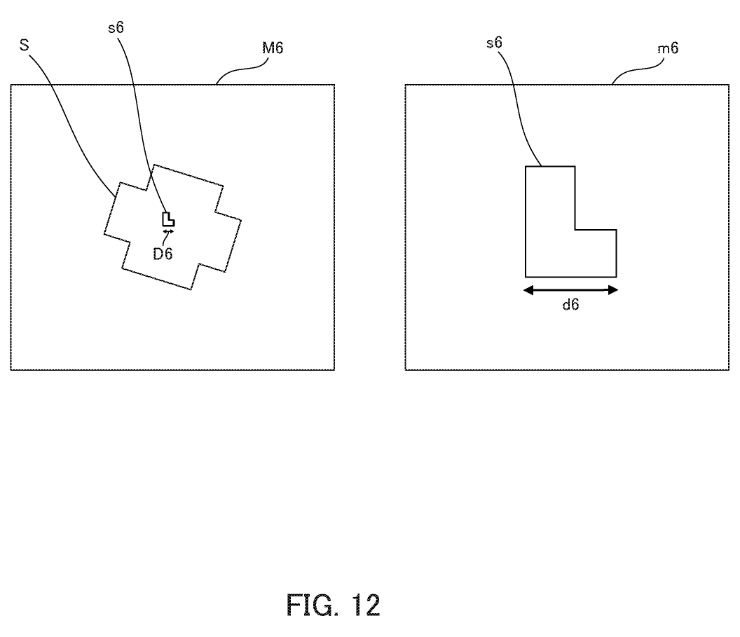

FIG. 12 is a diagram illustrating Method 2.

As illustrated in FIG. 12, when a macro image M6 and a micro image m6 are acquired, a pattern of a specific portion s6 common to the macro image M6 is detected from the micro image m6 by pattern matching. In addition, in a case where the pattern cannot be detected by pattern matching, the user may directly designate a common portion of the macro image M6 and the micro image m6. For example, it is also possible to obtain a relative dimension by clicking left and right ends of the common portion of the macro image M6 and the micro image m6 on the respective images with a mouse.

Since the magnification of the first optical system 102 and the pixel size of the first imaging element 106 are known, the size d6 (absolute dimension) of the specific portion s6 can be obtained from, for example, the number of pixels (relative dimension) of a horizontal size d6 of the specific portion s6 represented in the micro image m6. For example, it is assumed that this is 1 mm.

Since a pixel size of the second imaging element 204 is also known, a magnification of the macro image M6 can be obtained from a number of pixels (relative dimension) of, for example, a horizontal size D6 of the specific portion s6 represented in the macro image M6. For example, in a case where the pixel size of the second imaging element 204 is 2.4 μm and the number of pixels of the size D6 of the specific portion s6 represented in the macro image M6 is 21 pixels, the magnification of the macro image M6 is as follows.
(21×0.0024)/1=0.00504
The number of pixels of the size D6 of the specific portion s6 represented in the macro image M6 is also dimension information based on the macro image M6.

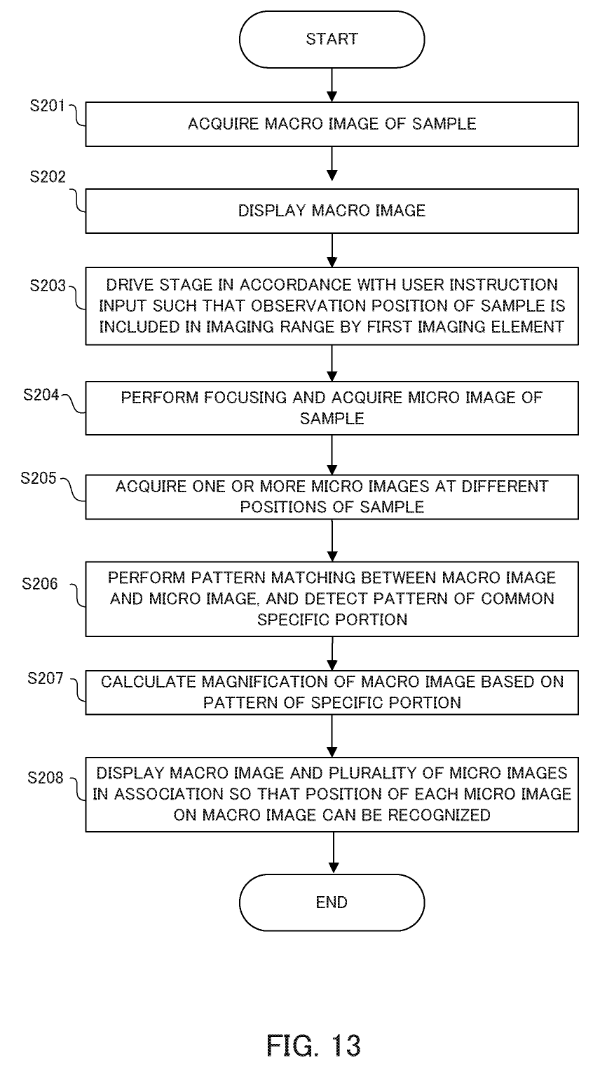

FIG. 13 is a flowchart illustrating details of mapping processing including processing of obtaining a magnification of a macro image by Method 2.

In the mapping processing illustrated in FIG. 13, first, the control unit 301 acquires a macro image of the sample S placed on the stage 111 by the second imaging element 204 (S201). Here, it is assumed that, in advance, driving of the stage 111 and the optical head 100 has been performed in accordance with a user instruction input (or a manual operation), and the sample S is included in an imaging range of the second imaging element 204 (an observation range of the second optical system 201).

Next, the control unit 301 displays the macro image acquired in S201 on the display 40 (S202).

Next, the control unit 301 drives the stage 111 in accordance with a user instruction input such that an observation position of the sample S is included in an imaging range by the first imaging element 106 (an observation range by the first optical system 102) (S203).

Next, the control unit 301 performs focusing (brings into focus) by the first optical system 102 by driving the optical head 100, and acquires a micro image of the sample S by the first imaging element 106 (S204). A magnification of the micro image acquired here (a magnification of the first optical system 102 when the micro image is acquired) is stored in the memory 302 as a calibration parameter.

Next, the control unit 301 performs, in accordance with an instruction input of the user, driving of the stage 111, the optical head 100, and the like, and acquisition of a micro image by the first imaging element 106 one or more times, and acquires one or more micro images at different positions of the sample S (S205).

Next, the control unit 301 performs pattern matching between the macro image acquired in S201 and the micro image acquired in S204, and detects, from the micro image, a pattern of a specific portion common to the macro image (S206).

Next, the control unit 301 calculates the magnification of the macro image based on the pattern of the specific portion detected in S206, pixel sizes of the first imaging element 106 and the second imaging element 204 stored in the memory 302, and the magnification of the micro image stored in the memory 302 (the magnification of the micro image acquired in S204), as described with reference to FIG. 12 (S207).

In this example, the magnification of the micro image stored in the memory 302 is the magnification of the micro image acquired in S204; however, the magnification may be a magnification of one micro image among one or more micro images acquired in S205.

Next, the control unit 301 associates the macro image acquired in S201 with the plurality of micro images acquired in S204 and S205 and displays them on the display 40 such that positions on the macro image of each of the micro images acquired in S204 and S205 can be recognized (S208). For example, the display content is also included in a report such as an inspection result. The display in S208 is performed, for example, based on XY coordinates of the macro image acquired in S201 (XY coordinates of a position of the stage 111 when the macro image was acquired), the magnification of the macro image calculated in S207, XY coordinates of each of the micro images acquired in S204 and S205 (XY coordinates of a position of the stage 111 when each micro image was acquired), a magnification of each micro image (a magnification of the first optical system 102 when each micro image was acquired), and the like.

As described above, according to the second embodiment, since the magnification of the macro image can be obtained by Method 2, it is possible, similarly to the first embodiment, to improve inspection efficiency by a mapping function using both macro observation and micro observation.

### Third Embodiment

In the third embodiment, instead of the mapping processing including the processing for obtaining the magnification of the macro image by Method 1 described in the first embodiment, mapping processing including processing for obtaining the magnification of the macro image by Method 3 is performed. Method 3 is a method used in a case where the sample S having a known dimension is observed.

In Method 3, first, a dimension of the sample S is registered. This registration is performed from a registration screen displayed on the display 40.

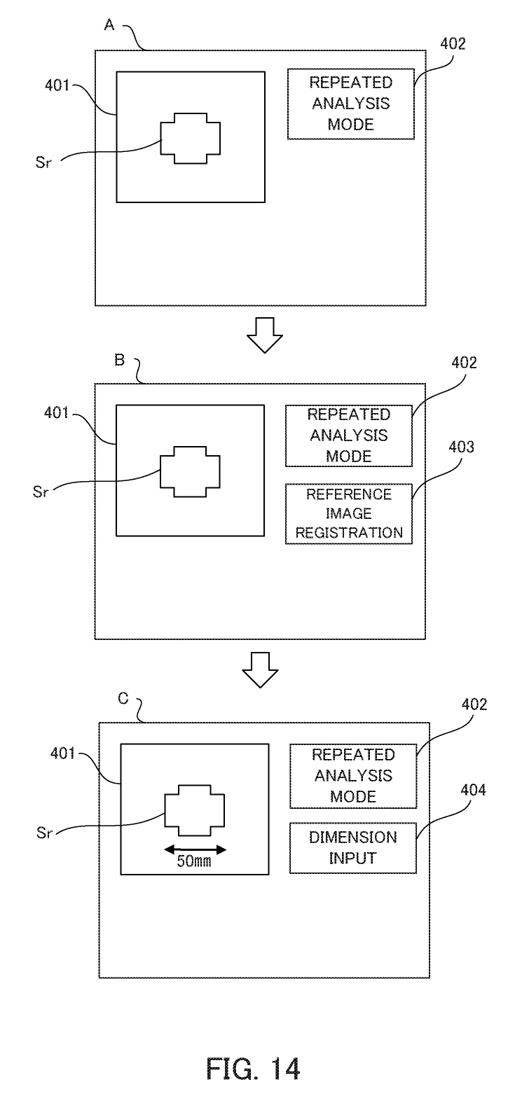

FIG. 14 is a diagram illustrating a registration screen.

In a registration screen A illustrated in FIG. 14, first, the user drives the stage 111 and the optical head 100 by an instruction input such that a macro image of a registration sample (a sample to be registered) Sr placed on the stage 111 is displayed in a macro image display region 401. The macro image display region 401 corresponds to an imaging range of the second imaging element 204 (an observation range of the second optical system 201). The macro image displayed in the macro image display region 401 at this time is also a live image. When the user presses a “Repeated analysis mode” button 402 on the registration screen A, the registration screen A transitions to a registration screen B.

In the registration screen B, when the user presses a “Reference image registration” button 403, the macro image displayed in the macro image display region 401 is acquired, and the registration screen B transitions to a registration screen C. Although this is a registration image, by performing Artificial Intelligence (AI) learning using images of one or more registration samples at the time of registration, it is also possible to automatically recognize the registration sample at the time of later macro image acquisition even in a case where the registration sample is observed with a different orientation, a different position, or a different size (for example, in a case where the magnification changes due to a position of the optical head 100).

In the registration screen C, the acquired macro image is displayed in the macro image display region 401, and a dimension input of the registration sample Sr is accepted from the user. When the user presses a “Dimension input” button 404, the user can input a dimension (absolute dimension) of the registration sample Sr. The input dimension is, for example, a horizontal (or vertical) dimension of the registration sample Sr, and is input with reference to drawing information of the registration sample Sr. The input dimension is superimposed and displayed on the macro image displayed in the macro image display region 401. In the illustrated registration screen C, “50 mm” is superimposed and displayed as a horizontal dimension of the registration sample Sr. The dimension of the registration sample Sr input in this manner is stored in the memory 302. Further, the macro image of the registration sample Sr is stored (registered) in the memory 302 as a registration image. The dimension of the registration sample Sr may be obtained, for example, from Computer Aided Design (CAD) information of the registration sample Sr.

Next, acquisition of a macro image of the sample S that is an inspection target is performed. This acquisition is performed from a macro image acquisition screen displayed on the display 40.

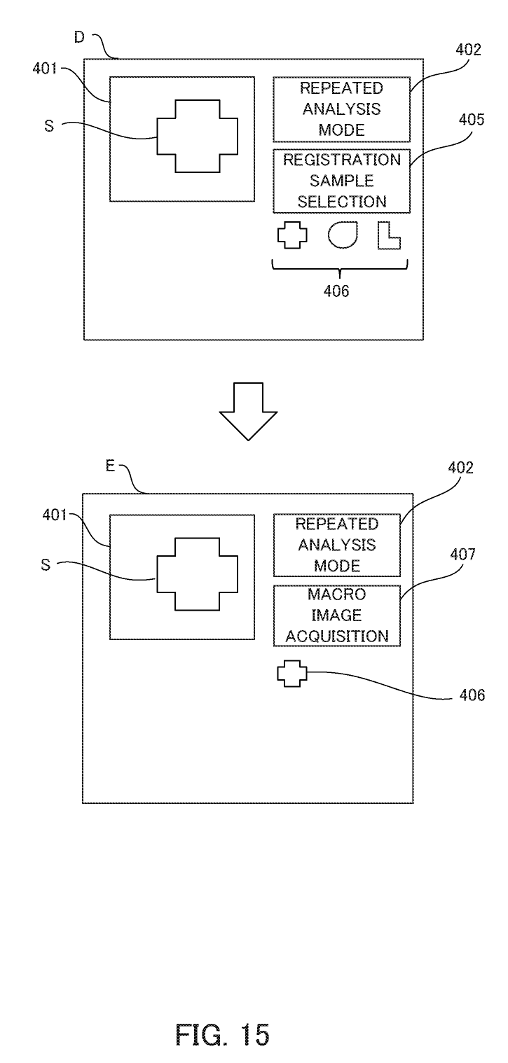

FIG. 15 is a diagram illustrating a macro image acquisition screen.

On a macro image acquisition screen D illustrated in FIG. 15, first, the user drives the stage 111 and the optical head 100 by an instruction input such that a macro image of the sample S placed on the stage 111 is displayed in the macro image display region 401. The macro image displayed in the macro image display region 401 at this time is a live image. When the user presses a “Registration sample selection” button 405 and selects, from among one or more registration sample icons 406 corresponding to the registration samples Sr whose dimensions have been registered, the registration sample icon 406 corresponding to the registration sample Sr that is the same as the sample S, a macro image acquisition screen D transitions to a macro image acquisition screen E. The registration sample icon 406 is an icon that imitates the registration sample Sr.

In the macro image acquisition screen E, only the selected registration sample icon 406 is displayed as the registration sample icons 406. When the user presses a “Macro image acquisition” button 407, the macro image displayed in the macro image display region 401 is acquired.

When the macro image of the sample S is obtained in this manner, the magnification of the macro image is calculated as follows. For example, in a case where the pixel size of the second imaging element 204 is 2.4 μm, the number of pixels in the horizontal direction of the sample S represented in the macro image (relative dimension) is 1042, and the horizontal dimension of the sample S (absolute dimension) is the above-described 50 mm, the magnification of the macro image of the sample S is as follows.
(1042×0.0024)/50=0.050016

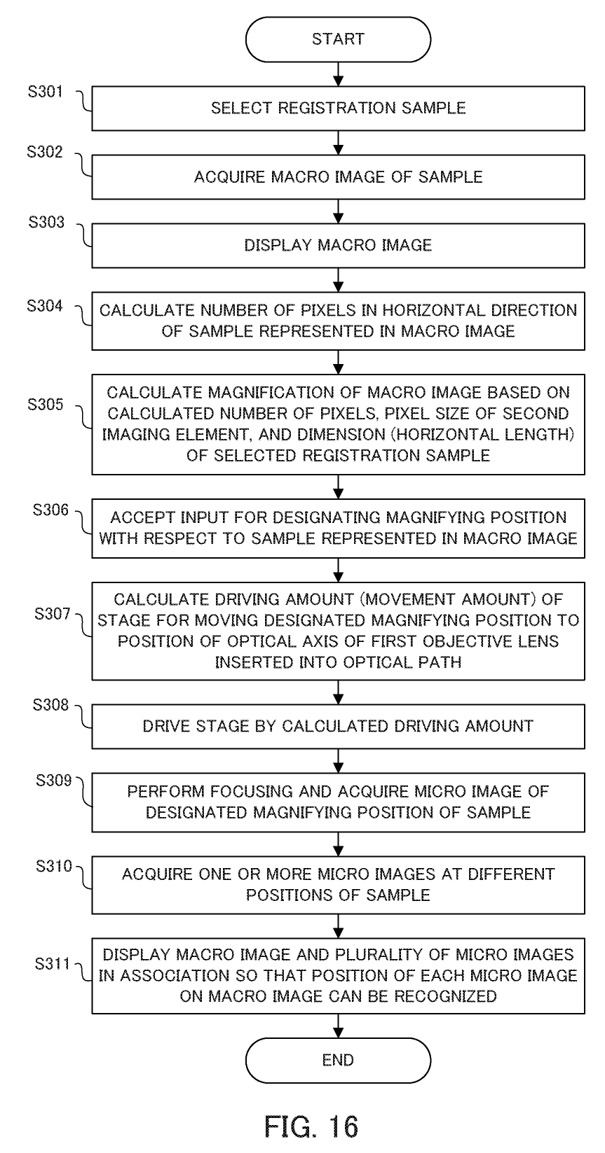

FIG. 16 is a flowchart illustrating details of mapping processing including processing of obtaining a magnification of a macro image by Method 3. In this processing, it is assumed in advance that absolute dimensions of a registration sample Sr are stored in the memory 302 as calibration parameters.

In the mapping processing illustrated in FIG. 16, first, the control unit 301 selects the registration sample Sr that is identical to the sample S, in accordance with a user instruction input (S301). This selection is performed by the user pressing the “Registration sample selection” button 405 and selecting a corresponding registration sample icon 406 on the macro image acquisition screen D illustrated in FIG. 15.

Next, the control unit 301 acquires a macro image of the sample S (S302). This acquisition is performed by the user pressing the “Macro image acquisition” button 407 on the macro image acquisition screen E illustrated in FIG. 15 above.

Next, the control unit 301 displays the macro image acquired in S302 on the display 40 (S303).

Next, the control unit 301 calculates the number of pixels (relative dimension) in the horizontal direction of the sample S represented in the macro image acquired in S302 (S304). The number of pixels calculated in S304 is also dimension information based on the macro image.

Next, the control unit 301 calculates the magnification of the macro image acquired in S302, based on the number of pixels calculated in S304, the pixel size of the second imaging element 204 stored in the memory 302, and the dimension (horizontal length) of the registration sample Sr selected in S301 (which is also the dimension of the registration sample Sr stored in the memory 302), as described above (S305).

Next, the control unit 301 performs the processing of S306 to S311. Since the processing of S306 to S311 is the same as the processing of S105 to S110 of the mapping processing illustrated in FIG. 11, description thereof is omitted.

As described above, according to the third embodiment, since the magnification of the macro image can be obtained by Method 3, it is possible, similarly to the first embodiment, to improve inspection efficiency by a mapping function using both macro observation and micro observation.

### Fourth Embodiment

In the fourth embodiment, instead of the mapping processing including the processing for obtaining the magnification of the macro image by Method 1 described in the first embodiment, mapping processing including processing for obtaining the magnification of the macro image by Method 4 is performed. Method 4 is a method of obtaining a magnification of a macro image based on a displacement amount (shift amount) of the sample S represented in two macro images of the sample S acquired before and after driving the stage 111 by a predetermined amount.

In Method 4, first, a macro image of the sample S is acquired, and next, the stage 111 is driven by a predetermined amount and a macro image of the sample S is acquired again. Acquisition of these two macro images is performed from a macro image acquisition screen displayed on the display 40.

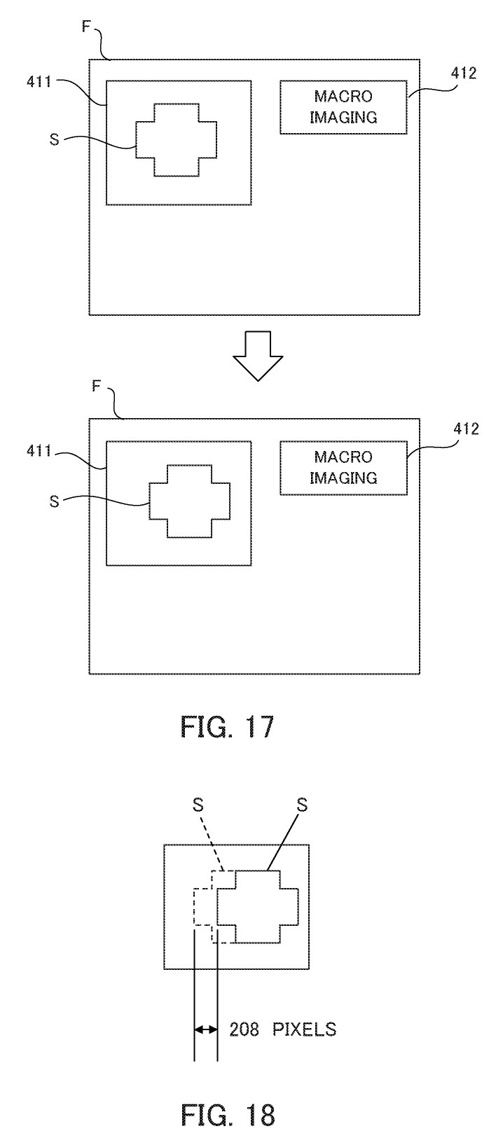

FIG. 17 is a diagram illustrating a macro image acquisition screen.

On the macro image acquisition screen F illustrated in the upper part of FIG. 17, the user first drives the stage 111 and the optical head 100 in accordance with an instruction input such that a macro image of the sample S is displayed in a macro image display region 411. The macro image display region 411 corresponds to an imaging range of the second imaging element 204 (an observation range of the second optical system 201). The macro image displayed in the macro image display region 411 at this time is also a live image. Then, when the user presses a “Macro imaging” button 412, the macro image displayed in the macro image display region 411 is acquired as a first macro image. When the first macro image is acquired, the stage 111 is driven in the X direction by a predetermined amount (for example, 5 mm). As a result, the sample S represented in the macro image moves, as illustrated in the macro image display region 411 of the macro image acquisition screen F illustrated in the lower part of FIG. 17. When the stage 111 is driven in the X direction by the predetermined amount, the macro image displayed in the macro image display region 411 is acquired as a second macro image.

After the two macro images before and after the driving are acquired in this manner, next, the number of pixels corresponding to an amount of displacement in the X direction of the sample S represented in the two macro images is obtained.

FIG. 18 is a diagram schematically illustrating an amount of displacement in an X direction of a sample represented in a macro image. In the example illustrated in FIG. 18, the number of pixels corresponding to the amount of displacement in the X direction between the sample S represented in the first macro image (sample S indicated by a broken line) and the sample S represented in the second macro image (sample S indicated by a solid line) is 208 pixels.

When the number of pixels corresponding to the amount of displacement in the X direction of the sample S represented in the two macro images is obtained in this manner, the magnification of the macro image is obtained from the number of pixels, the pixel size of the second imaging element 204, and the driving amount of the stage 111 in the X direction (the predetermined amount described above). For example, in a case where the number of pixels corresponding to the amount of displacement in the X direction of the sample S represented in the two macro images is the above-described 208 pixels, the pixel size of the second imaging element 204 is 2.4 μm, and the driving amount of the stage 111 in the X direction is the above-described 5 mm, the magnification of the macro image is as follows.
(0.0024×208)/5=0.09984

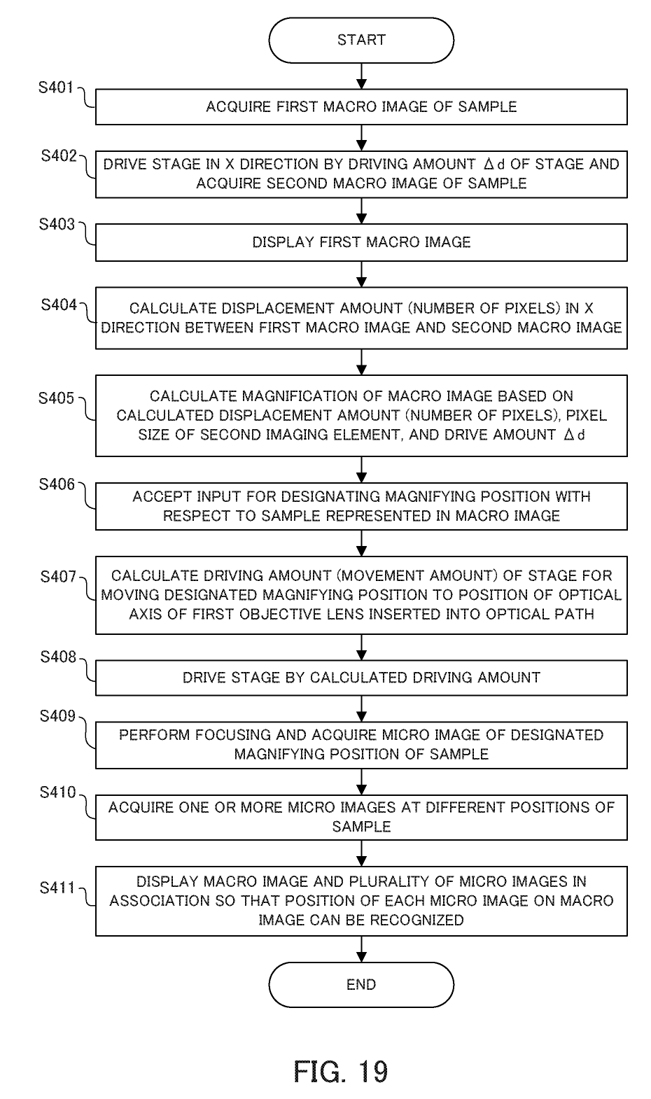

FIG. 19 is a flowchart illustrating details of mapping processing including processing of obtaining a magnification of a macro image by Method 4. In this processing, it is assumed in advance that a driving amount Δd of the stage 111 (the predetermined amount described above) is stored in the memory 302 as a calibration parameter.

In the mapping processing illustrated in FIG. 19, first, the control unit 301 acquires a first macro image of the sample S placed on the stage 111 by the second imaging element 204 (S401). This acquisition is performed when the user presses a “Macro imaging” button 412 on the macro image acquisition screen F illustrated in the upper part of FIG. 17 above.

Next, the control unit 301 drives the stage 111 in the X direction by the driving amount Δd of the stage 111 stored in the memory 302, and acquires a second macro image of the sample S (S402).

Next, the control unit 301 displays the first macro image acquired in S401 on the display 40 (S403).

Next, the control unit 301 calculates the number of pixels, which is an amount of shift in an X direction, between the sample S represented in the first macro image and the sample S represented in the second macro image (S404). The number of pixels calculated in S404 is also dimension information based on the macro image.

Next, the control unit 301 calculates the magnification of the macro image based on the number of pixels calculated in S404, the pixel size of the second imaging element 204 stored in the memory 302, and the driving amount Δd of the stage 111 stored in the memory 302, as described above (S405).

Next, the control unit 301 performs processing of S406 to S411. Since the processing of S406 to S411 is the same as the processing of S105 to S110 of the mapping processing illustrated in FIG. 11, description thereof is omitted.

As described above, according to the fourth embodiment, since the magnification of the macro image can be obtained by Method 4, it is possible, similarly to the first embodiment, to improve inspection efficiency by a mapping function using both macro observation and micro observation.

### Fifth Embodiment

In the fifth embodiment, instead of the mapping processing including the processing for obtaining the magnification of the macro image by Method 1 described in the first embodiment, mapping processing including processing for obtaining the magnification of the macro image by Method 5 is performed. Method 5 is a method for obtaining the magnification of the macro image by utilizing that the magnification of the second objective lens 202 changes depending on a distance between the second objective lens 202 and the sample S.

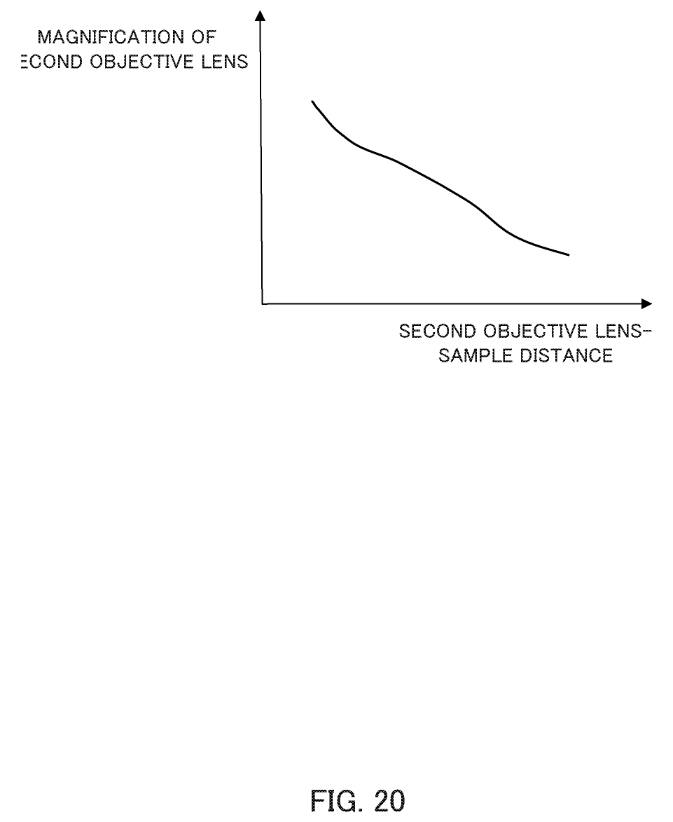

FIG. 20 is a diagram illustrating a relationship between a distance between a second objective lens and a sample and a magnification of the second objective lens.

As illustrated in FIG. 20, the magnification of the second objective lens 202 becomes smaller as the distance between the second objective lens 202 and the sample S becomes longer. This is also as illustrated in FIG. 8.

Therefore, in Method 5, relationship information indicating a relationship between the distance between the second objective lens 202 and the sample S and the magnification of the second objective lens 202 is obtained, for example, before factory shipment and stored in the memory 302, and the magnification of the macro image is obtained based on the relationship information.

Specifically, in Method 5, the magnification of the macro image is obtained as follows.

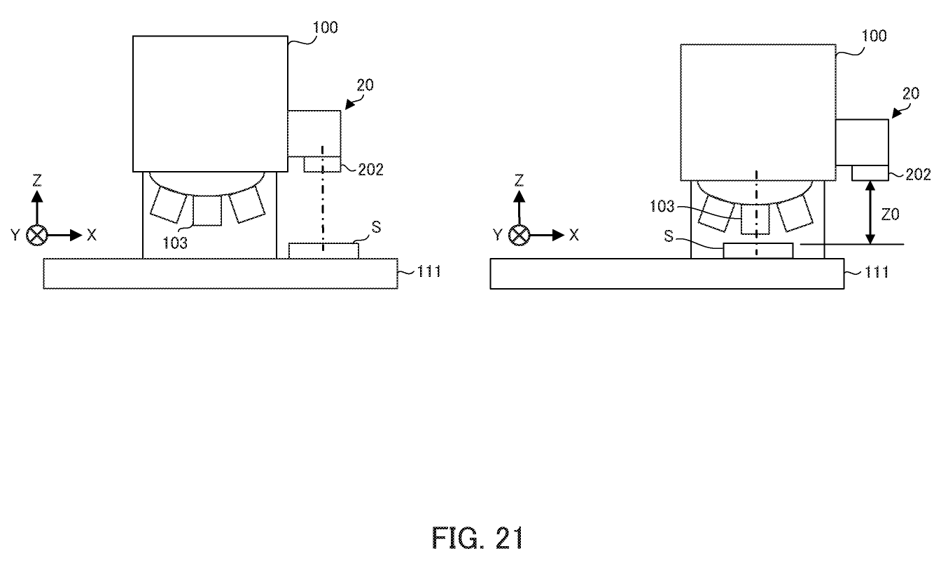

FIG. 21 is a diagram illustrating Method 5.

First, as illustrated on the left side of FIG. 21, a macro image of the sample S is acquired by the macro camera 20, and at the same time, a position in the Z direction (Z position) of the optical head 100 at that time is acquired as Z1. Here, a direction away from the sample S is defined as a positive direction of the Z direction.

Next, as illustrated on the right side of FIG. 21, the stage 111 is driven such that a position of an optical axis of the second objective lens 202 on the sample S is located at a position of an optical axis of the first objective lens 103 inserted into the optical path.

Next, by driving the optical head 100, focusing is performed by the first optical system 102, and a Z position at which focusing is achieved is acquired as Z2. At this time, a distance in the Z direction between the second objective lens 202 and the sample S is known, and the distance is defined as Z0.

Then, when a distance between the macro camera 20 (the second objective lens 202) and the sample S at a time when the macro image of the sample S is acquired by the macro camera 20, as illustrated on the left side of FIG. 21, is defined as Z3, the following relationship is satisfied:
Z3=Z0+Z1−Z2.

When Z3 is obtained in this manner, a magnification of the second objective lens 202 corresponding to Z3 (a magnification of the second objective lens 202 at a time when the macro image of the sample S is acquired by the macro camera 20), that is, the magnification of the macro image, is obtained from the relationship information described above (for example, the relationship information illustrating the relationship shown in FIG. 20).

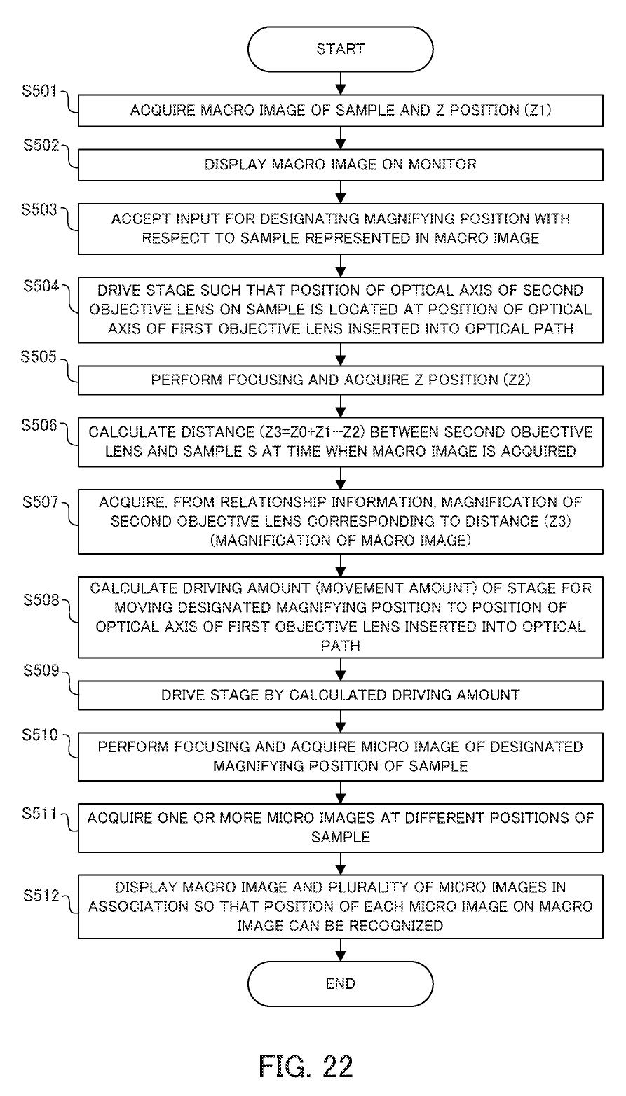

FIG. 22 is a flowchart illustrating details of mapping processing including processing of obtaining a magnification of a macro image by Method 5. In this processing, relationship information indicating a relationship between the distance between the second objective lens 202 and the sample S and the magnification of the second objective lens 202 is stored in advance in the memory 302.

In the mapping processing illustrated in FIG. 22, first, as illustrated on the left side of FIG. 21, the control unit 301 acquires a macro image of the sample S placed on the stage 111 by the macro camera 20 (the second imaging element 204), and acquires the Z position of the optical head 100 at that time as Z1 (S501). Here, it is assumed that, in advance, driving of the stage 111 and the optical head 100 has been performed in accordance with a user instruction input, and the sample S is included in an imaging range of the second imaging element 204 (an observation range of the second optical system 201).

Next, the control unit 301 displays the macro image acquired in S501 on the display 40 (S502).

Next, the control unit 301 accepts, from the user, an input for designating a magnifying position with respect to the sample S represented in the macro image displayed on the display 40 in S502 (S503). This input is performed, for example, by a mouse click operation.

Next, as illustrated on the right side of FIG. 21, the control unit 301 drives the stage 111 such that the position of the optical axis of the second objective lens 202 on the sample S is located at the position of the optical axis of the first objective lens 103 inserted into the optical path (S504). This driving also means that the stage 111 is driven by an amount corresponding to a distance between the optical axis of the first objective lens 103 inserted into the optical path and the optical axis of the second objective lens 202.

Next, by driving the optical head 100, the control unit 301 performs focusing by the first optical system 102, and acquires a Z position of the optical head 100 at a time when focusing is achieved as Z2 (S505).

Next, based on the Z position (Z1) acquired in S501, the Z position (Z2) acquired in S505, and Z0 which is a distance in the Z direction between the second objective lens 202 and the sample S at a time when focusing is achieved in S505, the control unit 301 calculates a distance Z3 (=Z0+Z1−Z2) between the second objective lens 202 and the sample S at a time when the macro image is acquired in S501 (S506).

Next, the control unit 301 acquires, from relationship information stored in the memory 302 (for example, relationship information illustrating the relationship illustrated in FIG. 20), a magnification of the second objective lens 202 corresponding to the distance (Z3) calculated in S506, that is, the magnification of the macro image (S507).

Next, the control unit 301 calculates a driving amount (movement amount) of the stage 111 for moving the magnifying position designated in S503 to the position of the optical axis of the first objective lens 103 inserted into the optical path (S508). This calculation is performed, for example, based on a center position of the macro image acquired in S501, a position on the macro image at which the magnifying position is designated in S503, a pixel size of the second imaging element 204, and the magnification or the like of the macro image acquired in S507.

Next, the control unit 301 performs processing of S509 to S512. Since the processing of S509 to S512 is the same as the processing of S107 to S110 of the mapping processing illustrated in FIG. 11, description thereof is omitted.

As described above, according to the fifth embodiment, since the magnification of the macro image can be obtained by Method 5, it is possible, similarly to the first embodiment, to improve inspection efficiency by a mapping function using both macro observation and micro observation.

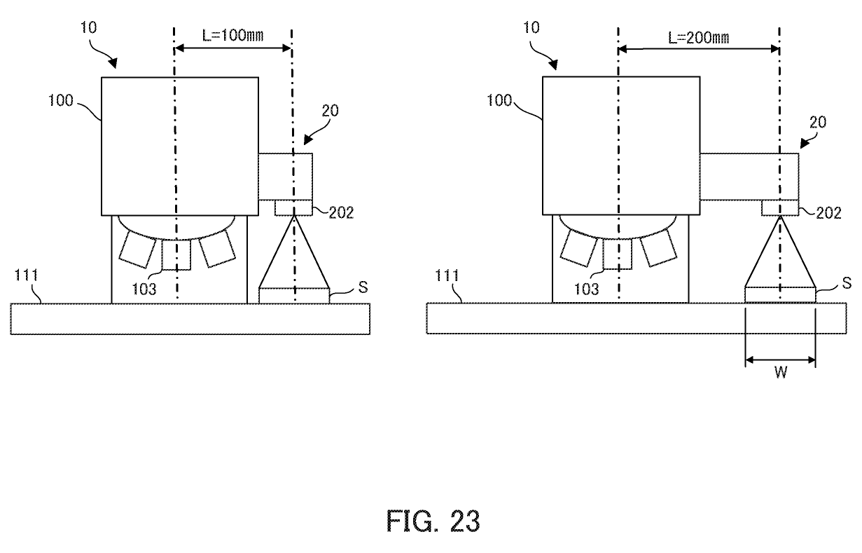

In each of the above embodiments, when a distance between the optical axis of the first objective lens 103 and the optical axis of the second objective lens 202 is defined as L, and a diagonal length of an observation range of the macro camera 20 (an imaging range of the second imaging element 204) is defined as W, it is desirable that L/W satisfies the following expression:
0.3<L/W<1
The reason will be described with reference to FIG. 23.

FIG. 23 is a diagram schematically illustrating examples in which L differs in a microscope to which a macro camera is attached. The left side illustrates a case where L is 100 mm, and the right side illustrates a case where L is 200 mm.

For example, in a case where W is set to 200 mm in order to make the observation range of the macro camera 20 sufficiently wide to accommodate various samples S, when L is set to 100 mm as illustrated on the left side of FIG. 23, L/W is 0.5 (=100/200). When L becomes short, the second objective lens 202 is arranged closer to the first objective lens 103, so an edge portion of the microscope 10 (for example, an edge portion of the first objective lens 103 outside the optical path attached to the revolver 101) may be included in the observation range of the macro camera 20, thereby restricting the observation range of the macro camera 20. Therefore, L such that L/W is 0.3 or less is not desirable, and a lower limit of L is approximately 80 mm. Note that when L is 80 mm, L/W is 0.4 (=80/200).

On the other hand, when L becomes long, in a case where the sample S that has been macro-observed by the macro camera 20 is micro-observed by the microscope 10, a movement distance of the stage 111 becomes long, so a movement time of the stage 111 becomes long. In addition, a large stage is required as the stage 111. Further, in a microscope 10 configured such that the sample S can be micro-observed from an oblique direction by inclining a part of the frame 120 holding the optical head 100 as illustrated in FIG. 3, when L becomes long, an inclinable angle range is restricted, and the angle range becomes narrow. For these reasons, L such that L/W is 1 or more is not desirable, and an upper limit of L is approximately 180 mm. Note that when L is 180 mm, L/W is 0.9 (=180/200).

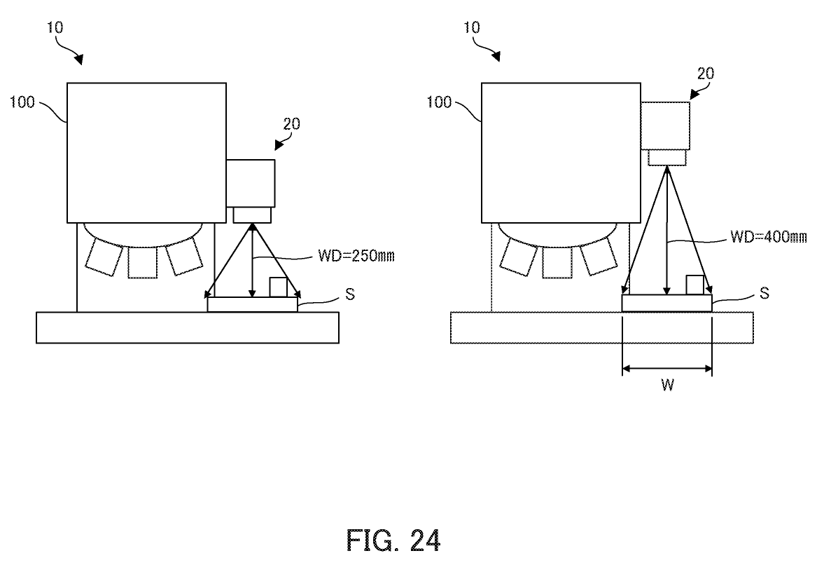

In each of the above embodiments, when a diagonal length of the observation range of the macro camera 20 (the imaging range of the second imaging element 204) is defined as W, and a working distance of the macro camera 20 (the second objective lens 202) is defined as WD, it is desirable that W/WD satisfies the following expression:
0.4<W/WD<1
The reason will be described with reference to FIG. 24.

FIG. 24 is a diagram schematically illustrating microscopes to which macro cameras having different WDs are attached. The left side illustrates a case where the macro camera 20 having WD of 250 mm is attached, and the right side illustrates a case where the macro camera 20 having WD of 400 mm is attached.

For example, in a case where W is set to 200 mm in order to make the observation range of the macro camera 20 sufficiently wide to accommodate various samples S, and WD is set to 250 mm as illustrated on the left side of FIG. 24, W/WD is 0.8 (=200/250). When WD is shorter than 250 mm and W/WD becomes 1 or more, an inclination of off-axis rays of the optical axis of the second objective lens 202 becomes large, so when the sample S has unevenness, an influence of shadows caused by protrusions becomes large. Therefore, a WD such that W/WD is equal to or greater than 1 is not desirable.

On the other hand, for example, when WD is set to 400 mm as illustrated on the right side of FIG. 24, W/WD is 0.5 (=200/400). When WD is longer than 400 mm and W/WD becomes 0.4 or less, an edge portion of the microscope 10 (for example, an edge portion of the optical head 100) restricts the observation range of the macro camera 20. Therefore, WD such that W/WD is 0.4 or less is not desirable.

Although the embodiment of the present invention has been described above, the present invention is not limited to the above-described embodiment, and various improvements and changes can be made without departing from the gist of the present invention.

What is claimed is:

1. A magnifying observation system comprising:
a stage on which a sample is placed;
a drive unit that drives the stage;
a first optical system including a first objective lens that is object-side telecentric;
a first imaging element that receives light from the sample via the first optical system and generates a first image of the sample;
a second optical system including a second objective lens that is object-side non-telecentric, in which an optical axis of the second objective lens is parallel to an optical axis of the first objective lens;
a second imaging element that receives light from the sample via the second optical system and generates a second image of the sample having a wider field of view than the first image;
a memory that stores pixel sizes of the first imaging element and/or the second imaging element, and calibration parameters;
a display that displays the first image and/or the second image; and
a processor, wherein
the processor
acquires the second image of the sample by the second imaging element,
calculates a magnification of the second image based on dimension information based on the second image, and the pixel sizes and the calibration parameters stored in the memory,
accepts designation of a magnifying position with respect to the sample represented in the second image displayed on the display,
controls the drive unit based on the magnifying position and the magnification such that the magnifying position is positioned at a position of the optical axis of the first objective lens, and
acquires, by the first imaging element, the first image of the magnifying position of the sample.

2. The magnifying observation system according to claim 1, wherein, when a distance between an optical axis of the first objective lens and an optical axis of the second objective lens is defined as L, and a diagonal length of an imaging range of the second imaging element is defined as W,
20.3 < L/W < 1 is satisfied.

3. The magnifying observation system according to claim 1, wherein, when a diagonal length of an imaging range of the second imaging element is defined as W, and a working distance of the second objective lens is defined as WD,
30.4 < W/WD < 1 is satisfied.

4. The magnifying observation system according to claim 1, wherein
the dimension information is a relative dimension of a scale represented in the second image,
the pixel size is a pixel size of the second imaging element, and
the calibration parameter is an absolute dimension of the scale.

5. The magnifying observation system according to claim 1, wherein
the dimension information is a relative dimension of the sample represented in the second image,
the pixel size is pixel sizes of the first imaging element and the second imaging element, and
the calibration parameter is a magnification of the first optical system.

6. The magnifying observation system according to claim 1, wherein
the dimension information is a relative dimension of the sample represented in the second image,
the pixel size is a pixel size of the second imaging element, and
the calibration parameter is an absolute dimension of the same sample as the sample represented in the second image.

7. The magnifying observation system according to claim 1, wherein
the processor acquires the second image of the sample by the second imaging element before and after driving the stage by a predetermined amount,
the dimension information is a displacement amount of the sample represented in two second images acquired before and after the driving,
the pixel size is a pixel size of the second imaging element, and
the calibration parameter is the predetermined amount.

8. A computer-readable storage medium storing a program for causing a computer of a magnifying observation system including
a stage on which a sample is placed,
a drive unit that drives the stage,
a first optical system including a first objective lens that is object-side telecentric,
a first imaging element that receives light from the sample via the first optical system and generates a first image of the sample,
a second optical system including a second objective lens that is object-side non-telecentric, in which an optical axis of the second objective lens is parallel to an optical axis of the first objective lens,
a second imaging element that receives light from the sample via the second optical system and generates a second image of the sample having a wider field of view than the first image; a memory that stores pixel sizes of the first imaging element and/or the second imaging element, and calibration parameters, and
a display that displays the first image and/or the second image, to execute processing of:
acquiring, by the second imaging element, the second image of the sample;
calculating a magnification of the second image based on dimension information based on the second image, and the pixel sizes and the calibration parameters stored in the memory;
accepting designation of a magnifying position with respect to the sample represented in the second image displayed on the display;
controlling the drive unit based on the magnifying position and the magnification such that the magnifying position is positioned at a position of an optical axis of the first objective lens; and
acquiring, by the first imaging element, the first image of the magnifying position of the sample.

9. A magnifying observation system comprising:
a stage on which a sample is placed;
a drive unit that drives the stage;
a first optical system including a first objective lens that is object-side telecentric;
a first imaging element that receives light from the sample via the first optical system and generates a first image of the sample;
a second optical system including a second objective lens that is object-side non-telecentric, in which an optical axis of the second objective lens is parallel to an optical axis of the first objective lens;
a second imaging element that receives light from the sample via the second optical system and generates a second image of the sample having a wider field of view than the first image;
a memory that stores pixel sizes of the first imaging element and/or the second imaging element, and calibration parameters;
a display that displays the first image and/or the second image; and
a processor, wherein
the processor
acquires the second image of the sample by the second imaging element,
calculates a magnification of the second image based on dimension information based on the second image, and the pixel sizes and the calibration parameters stored in the memory,
displays, on the display, the first image of the sample acquired by the first imaging element, and the second image,
acquires, from the drive unit, position information of the stage at a time when the first image is acquired, and
displays, on the second image displayed on the display, a position at which the first image is acquired based on the magnification of the second image and the position information.

10. The magnifying observation system according to claim 9, wherein
the first image is sequentially acquired as a live image, the position information of the stage is sequentially acquired in association with acquisition of the first image, and a position at a time when the first image is acquired is sequentially updated in association with acquisition of the first image.
